(19) United States
(12) Patent Application Publication
(10) Pub. No.: US 2011/0200204 A1
(43) Pub. Date: Aug. 18, 2011

(54) SPEAKER DEVICE

(75) Inventors: Minoru Horigome, Tendo-shi (JP); Koji Maekawa, Tendo-shi (JP); Toshihiro Hikichi, Tendo-shi (JP)

(73) Assignees: PIONEER CORPORATION, Tokyo (JP); TOHOKU PIONEER CORPORATION, Yamagata (JP)

(21) Appl. No.: 13/125,211

(22) PCT Filed: Jul. 9, 2009
(86) PCT No.: PCT/JP2009/062480

§ 371 Date: Apr. 20, 2011

(30) Foreign Application Priority Data
Oct. 23, 2008 (JP) PCT/JP2008/069269

(51) Int. Cl. H04R 9/06

(52) U.S. Cl. 381/86; 381/400; 381/398

(57) ABSTRACT

To provide a thin speaker device capable of emitting a loud reproduced sound with a comparatively simple structure, and to input the audio signal to the voice coil not to have an adverse effect on the vibration of the voice coil is executed. A speaker device includes a vibration direction converter part transmitting the vibration of the voice coil to the diaphragm, and a holding part holding the voice coil at the static part such that the voice coil vibrates linearly, and the audio signal inputted to an audio signal input terminal provided at the static part is inputted to the voice coil via the holding part.

### FIELD OF THE INVENTION

The present invention relates to a speaker device.

### BACKGROUND OF THE INVENTION

As a general speaker device, a dynamic speaker device as disclosed is known (for example, see patent literature 1). For example, as shown in FIG. 1, the dynamic speaker device described in this publication includes a frame 3J, a cone-shaped diaphragm 21J, an edge 4J which supports the diaphragm 21J to the frame 3J, a voice coil bobbin 610J joined to the inner periphery of the diaphragm 21J, a damper 7J which supports the voice coil bobbin 610J to the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by the Lorentz force developed in the voice coil 611J in the magnetic gap and the diaphragm 21J is driven by the vibration.
[Patent literature 1] Publication of unexamined patent application H8-149596 (FIG. 1)

The general dynamic speaker device described above is, for example as shown in FIG. 1, configured such that the voice coil 611J is disposed opposite to the sound emission side of the diaphragm 21J, and the vibration direction of the voice coil 611J and the voice coil bobbin 610J is the same as the vibration direction of the diaphragm 21J. In such a speaker device, a region for vibration of the diaphragm 2J, a region for vibration of the voice coil bobbin 610J, and a region for arranging the magnetic circuit, etc. are formed along the vibration direction (sound emission direction) of the diaphragm 21J. Accordingly, the total height of the speaker device inevitably becomes comparatively large.

Specifically, as shown in FIG. 1, the dimension of the speaker device along the vibration direction of the diaphragm 21J is defined by: (a) the height of the cone-shaped diaphragm 21J along the vibration direction plus the total height of the edge 4J which supports the diaphragm 21J to the frame 3J, (b) the height of the voice coil bobbin from the junction of the diaphragm 21J and the voice coil bobbin 610J to the upper end of the voice coil 611J, (c) the height of the voice coil, (d) the height mainly of the magnet of the magnetic circuit, corresponding to the height from the lower end of the voice coil 611J to the upper end of the yoke 51J, and (e) the thickness mainly of the yoke 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to obtain a sufficient driving force. Accordingly, particularly in a speaker device for large volume, the total height of the speaker device inevitably becomes large.

Since the vibration direction of the voice coil bobbin 610J is the same direction as the vibration direction of the diaphragm 21J in conventional speaker devices as described above, the total height of the speaker devices inevitably becomes large to ensure the vibration stroke of the voice coil bobbin 610J, when seeking a large volume of sound by increasing the amplitude of the diaphragm 21J. Thus, it becomes difficult to make a device thin. In other words, making a device thin and securing a large volume of sound are contradictory.

Nevertheless, in order to efficiently transmit the vibration of the voice coil 611J to the diaphragm 21J, a direct transmission of the vibration from the voice coil 611J to the diaphragm 21J, i.e. the alignment of the vibration direction of the voice coil 611J and the vibration direction of the diaphragm 21J is preferable. In the case that the vibration direction of the voice coil 611J and the vibration direction of the diaphragm 21J are different, the vibration of the voice coil 611J may not be securely transmitted to the diaphragm 21J, which may cause deterioration of the reproduction efficiency of the speaker device. In particular, in order to obtain a preferable reproduction characteristic in a high-tone range, it is necessary to securely transmit the vibration of the voice coil 611J to the diaphragm.

In a general speaker device, a lead wire (speaker wire) connected to the end part of the voice coil 611J is wired to connect with a signal terminal arranged at a frame in order to input the audio signal to the voice coil 611J. According to the foregoing configuration, when the voice coil vibrates in response to the audio signal, the lead wire vibrates with the voice coil, and thereby having an adverse effect on the vibration of the voice coil.

It is an object of the present invention to overcome the problem described above. That is, an object of the present invention is to provide a thin speaker device capable of emitting a loud reproduced sound, provide a speaker device with high reproduction efficiency by securely transmitting the vibration of the voice coil to the diaphragm, and input the audio signal to the voice coil not to have an adverse effect on the vibration of the voice coil, etc.

### SUMMARY OF THE INVENTION

To achieve the above-mentioned object, a speaker device according to the present invention has at least a configuration according to the following independent claim:

[Claim 1] A speaker device including a diaphragm; a static part vibratably supporting said diaphragm; and a driving part provided at said static part, vibrating said diaphragm upon an audio signal, wherein said driving part includes, a tabular plate shape voice coil vibrating in a direction different from a direction in which said diaphragm vibrates in response to an audio signal inputted, a magnetic circuit having a magnetic gap in which said voice coil is arranged, a rigid vibration direction converter part transmitting said vibration of said voice coil to said diaphragm, and a holding part holding said voice coil at said static part such that said voice coil vibrates linearly, and the audio signal inputted to an audio signal input terminal provided at said static part is inputted to said voice coil via said holding part.

### BRIEF DESCRIPTION OF THE DRAWINGS

FIG. 1 is a view illustrating a speaker device of a prior art;

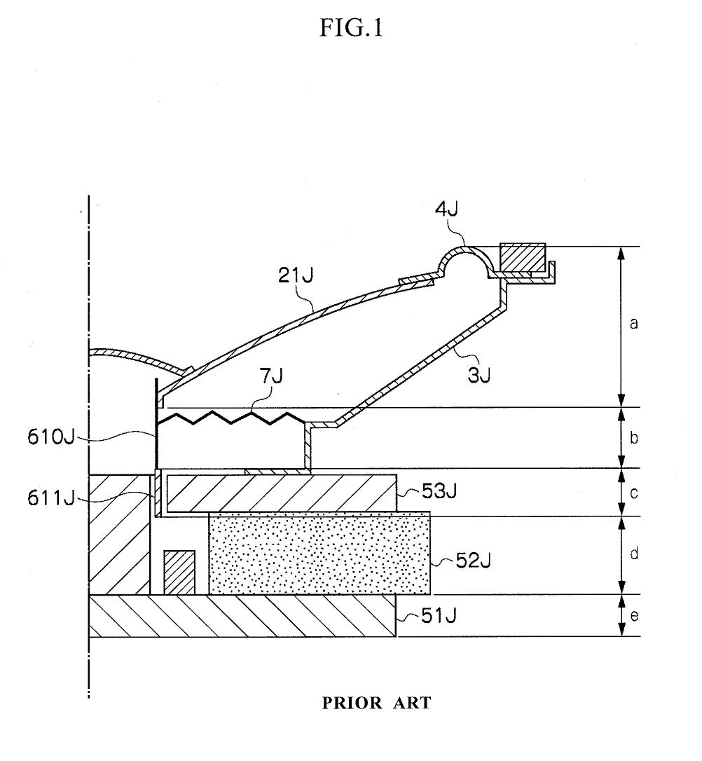

FIGS. 2(a) and (b) are views illustrating a basic configuration of the speaker device according to an embodiment of the present invention;

FIG. 3 is a view illustrating a basic configuration (driving part) of the speaker device according to an embodiment of the present invention;

FIG. 4 is a view illustrating a basic configuration (driving part) of the speaker device according to an embodiment of the present invention;

FIG. 5 is a view illustrating a basic configuration (driving part) of the speaker device according to an embodiment of the present invention;

FIGS. 6(a)-(c) are views illustrating a basic configuration (operation of vibration direction converter part) of the speaker device according to an embodiment of the present invention;

FIG. 7 is a view illustrating a configuration example (holding body of voice coil with holding part) of the speaker device according to an embodiment of the present invention;

FIG. 8 is a view illustrating a configuration example (holding body of voice coil with holding part) of the speaker device according to an embodiment of the present invention;

FIG. 9 is a view illustrating a configuration example (holding body of voice coil with holding part) of the speaker device according to an embodiment of the present invention (FIG. 9(a) is a back perspective view and FIG. 9(b) is a front perspective view);

FIGS. 10(a) and (b) are views illustrating a configuration example of a vibration direction converter part according to an embodiment of the present invention;

FIGS. 11(a)-(c) are views illustrating a configuration example of a vibration direction converter part according to an embodiment of the present invention;

FIGS. 12(a)-(c) are views illustrating a configuration example of a vibration direction converter part according to an embodiment of the present invention;

FIGS. 13(a)-(c) are views illustrating a configuration example of a vibration direction converter part according to an embodiment of the present invention;

FIGS. 14(a) and (b) are views illustrating a configuration example of a vibration direction converter part according to an embodiment of the present invention;

FIG. 15 is a view illustrating a speaker device according to an embodiment of the present invention (plan view except diaphragm);

FIG. 16 is a view illustrating a speaker device according to an embodiment of the present invention (plan view except diaphragm);

FIG. 17 is a view illustrating a speaker device according to an embodiment of the present invention (plan view except diaphragm);

FIG. 18 is a view illustrating a speaker device according to an embodiment of the present invention (cross-sectional view except diaphragm);

FIG. 19 is a view illustrating a speaker device according to another embodiment of the present invention;

FIG. 20 is a view illustrating a speaker device according to another embodiment of the present invention;

FIG. 21 is a view illustrating a speaker device according to another embodiment of the present invention;

FIG. 22 is a view illustrating a speaker device according to another embodiment of the present invention;

FIG. 23 is a view illustrating a speaker device according to another embodiment of the present invention;

FIG. 24 is a view illustrating a speaker device according to another embodiment of the present invention;

FIG. 25 is a view illustrating a speaker device according to another embodiment of the present invention;

FIGS. 26(a) and (b) are views illustrating a speaker device according to another embodiment of the present invention;

FIG. 27 is a view illustrating an assembly structure of a speaker device according to an embodiment of the present invention;

FIGS. 28(a) and (b) are views illustrating an electronic device using a speaker device according to an embodiment of the present invention; and

FIG. 29 is a view illustrating a vehicle using a speaker device according to an embodiment of the present invention.

### DETAILED DESCRIPTION OF THE INVENTION

A speaker device according to an embodiment of the present invention includes a diaphragm, a static part vibratably supporting the diaphragm in the vibration direction and a driving part, provided at the static part, vibrating the diaphragm upon an audio signal, and the driving part includes a tabular plate shape voice coil vibrating in a direction different from a direction in which said diaphragm vibrates in response to the audio signal inputted, a magnetic circuit having a magnetic gap in which the voice coil is arranged, a rigid vibration direction converter part transmitting said vibration of the voice coil to the diaphragm and a holding part holding the voice coil at the static part such that the voice coil vibrates linearly, and the audio signal inputted to an audio signal input terminal provided at the static part is inputted to the voice coil via the holding part.

In the speaker device with the above described features, when the audio signal is inputted to the voice coil of the driving part, a Lorentz force is generated at the voice coil arranged in the magnetic gap of the magnetic circuit and the voice coil vibrates in a different direction compared with the vibration direction of the diaphragm, preferably in a direction orthogonally to the vibration direction of the diaphragm. On the other hand, the vibration direction converter part converts the vibration direction of the voice coil and transmits the vibration of the voice coil to the diaphragm. The diaphragm vibrates in a different vibration direction compared with the voice coil (for example, orthogonally to the voice coil) by a driving force transmitted via the vibration direction converter part.

In a general speaker device, for example, a voice coil bobbin is arranged on the back side of the diaphragm such that the vibration direction of the diaphragm and the vibration direction of the voice coil bobbin are aligned. Since the diaphragm and the voice coil bobbin require their respective space for vibration in the vibration direction, the width in the sound emission direction of the speaker device is comparatively large.

In contrast, the speaker device according to an embodiment of the present invention includes a magnetic circuit having a magnetic gap formed in a different direction than the vibration direction of the diaphragm, preferably in a direction orthogonally to the vibration direction of the diaphragm, a voice coil vibrating along the magnetic circuit, and a vibration direction converter part converting the vibration direction of the voice coil and transmitting the vibration to the diaphragm, and thus the width in the sound emission direction is comparatively small compared to the above general speaker device. That is, a thin speaker device can be provided. Since a vibration stroke of the voice coil can be configured in a direction having no effect on the total length of the speaker device, the speaker device can be easily made thin even when the vibration stroke of the voice coil, that is, the vibration amplitude of the diaphragm is made large. This will enable a speaker device to be made thin while producing a loud sound.

Also, since the speaker device according to an embodiment of the present invention includes a holding part holding the voice coil at a static part such that the voice coil vibrates linearly, the vibration of the voice coil that is held at the holding part and vibrates linearly is transmitted to the diaphragm via the vibration direction converter part, and thus the diaphragm can be vibrated efficiently.

Also, since the audio signal inputted to the audio signal input terminal provided at the static part is inputted to the voice coil via the holding part, a lead wire electrically connecting the voice coil to the audio signal input terminal can be prevented from having an adverse effect on the vibration of the voice coil due to the vibration by the lead wire vibrating with the vibration of the voice coil. Further, since no space is required for an extra length of the above lead wire, a space inside a frame as the static part can be saved, and thus an overall speaker device can be made compact and thin.

Since the connecting wire between the voice coil and the audio signal input terminal integrally moves with the holding part, the connecting wire can be prevented an abnormal noise and wire breakage from being caused by the connecting wire interfering a vibrating member in the driving part.

More specifically, the holding part formed with conductive metal is electrically connected to the end part of the voice coil or a lead wire from the end part of the voice coil, and is electrically connected to the audio signal input terminal at the end part in the side of the static part. With this configuration, the holding part itself functions as a connecting wire, no extra wire is necessary. The connecting the end part of voice coil with the holding part in the side of the static part or in the side of the voice coil also serves as an electrical connection of the connecting wire, and thus the manufacturing process can be simplified. Also, since the holding part can have the high rigidity in the direction other than the vibration direction with the metal member, the vibration of the voice coil can be securely restricted.

Also, the holding part is a curved plate member that allows an elastic deformation in one direction aligned with the vibration direction of the voice coil and restricts the deformation in other directions. With this configuration, the curved plate member can elastically deform in the curved direction of the curved plate member, while the curved plate member may have high rigidity in a direction orthogonally to the curved direction of the curved plate member. With this configuration, the vibration direction of the voice coil can be linearly restricted accurately with a simple processed member.

Also, the holding part holds the voice coil left-right symmetrically. With this configuration, the linearly vibrating voice coil can be stably held without generating inclination or rolling.

Also, the right and left holding parts are integrated so as to hold a side of the end edge of the voice coil. This will enable reinforcement of a side of end edge of the voice coil by using the characteristic of the holding part having high rigidity in the direction orthogonally to the vibration direction of the voice coil, thereby restraining deformation or breakage of the voice coil in vibrating the voice coil and improving durability of the speaker device.

Also, the vibration direction converter part includes a link body that converts an angle of a link part arranged between the voice coil and the diaphragm in response to the vibration of the voice coil and a reaction force exerted from the static part. This will enable secure transmission of the vibration of the voice coil to the diaphragm while receiving a reaction force from the static part, and therefore preferable transmission efficiency of vibration can be obtained and preferable reproduction efficiency of the speaker device can be obtained even when the vibration direction of the voice coil differs from the vibration direction of the diaphragm. Particularly, vibration of the voice coil being securely transmitted to the diaphragm, preferable reproduction characteristic of high frequency range can be obtained.

Further, the frame includes a planar bottom face, the diaphragm is planarly supported along the bottom face of the frame, the magnetic gap is formed along the bottom face of the frame, and the vibration direction converter part is configured to vibrate the diaphragm in the direction intersecting the bottom face in response to a reaction force exerted from the bottom face of the frame. This will enable the whole speaker device to be formed in a planar shape along the bottom face of the frame, and thus the whole device can be made thin.

Further, the magnetic circuit includes a pair of magnetic gaps generating magnetic fields in directions opposite to each other, and the voice coil is planarly formed and is annularly formed such that currents flow in the opposite directions in the pair of magnetic gaps. This will enable the planar voice coil to planarly vibrate with a large driving force by using a pair of magnetic gaps, and a rectilinear vibration with comparatively small fluctuation can be achieved by increasing planar rigidity of the voice coil. Particularly, in the speaker device including planar frame bottom face described above, the thin space above the frame bottom face can be used for vibration space of the voice coil, and thus space efficiency in the thickness direction of the speaker device can be improved.

Further, a pair of driving parts is provided such that the vibration direction converter parts are disposed in the opposite sides each other substantially symmetrically. A single diaphragm can be vibrated by combined driving forces exerted from a pair of driving parts with reversely synchronized vibrations of opposed voice coils, and thus the large driving force can be obtained even with a thin and compact speaker device.

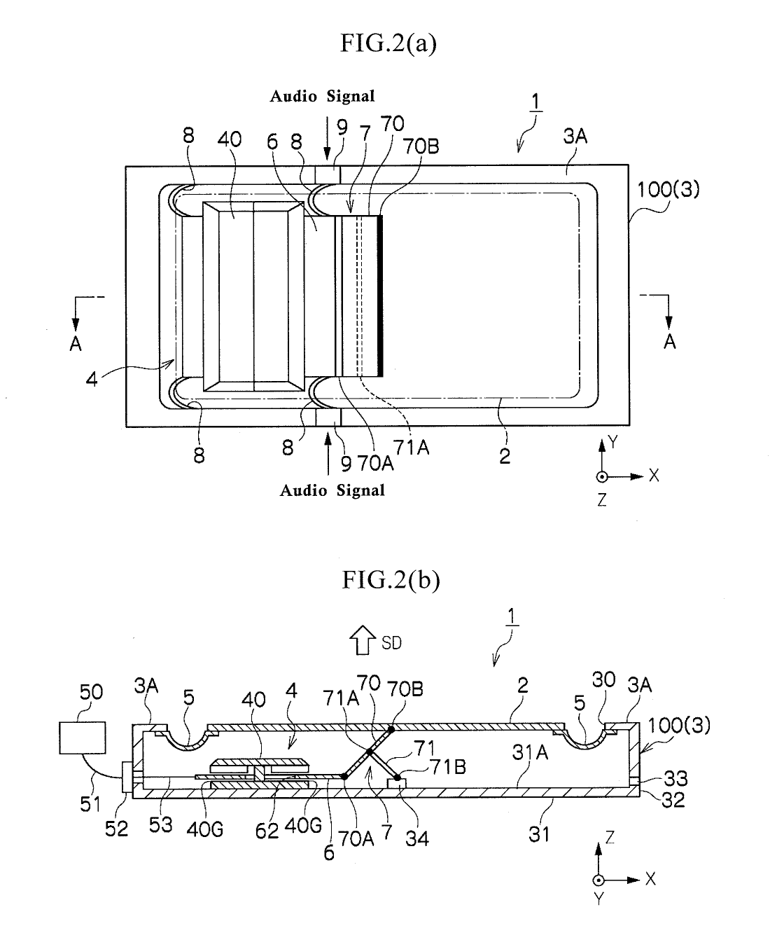

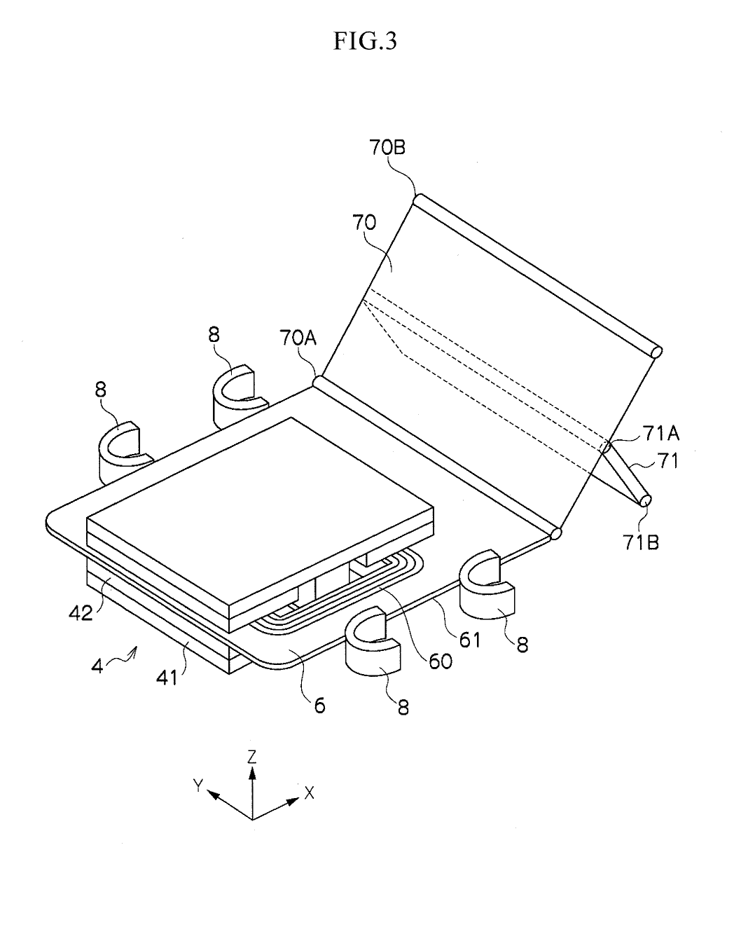

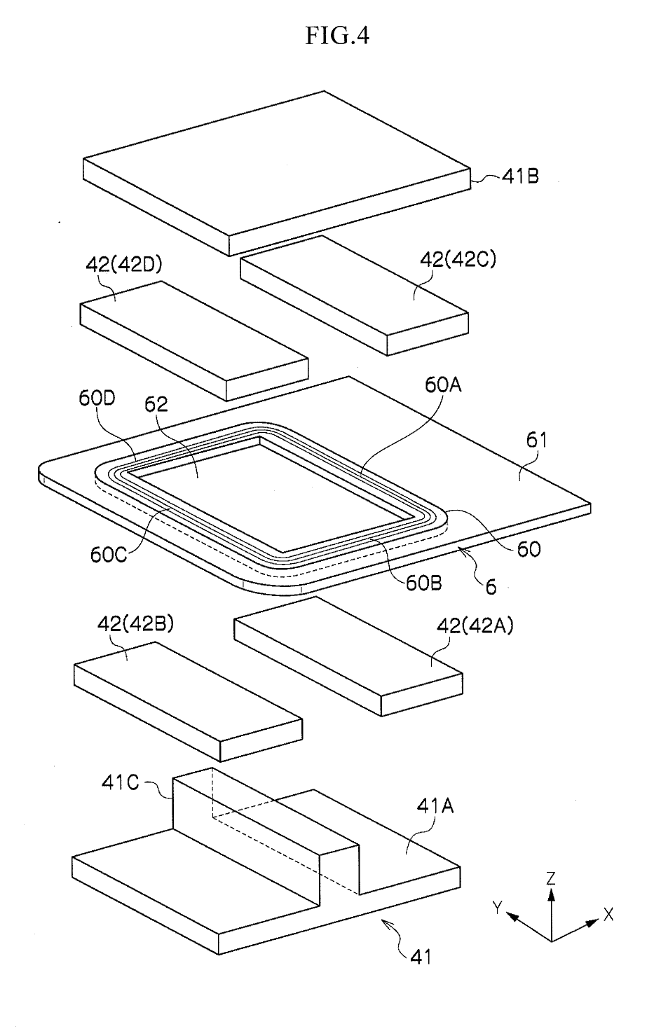

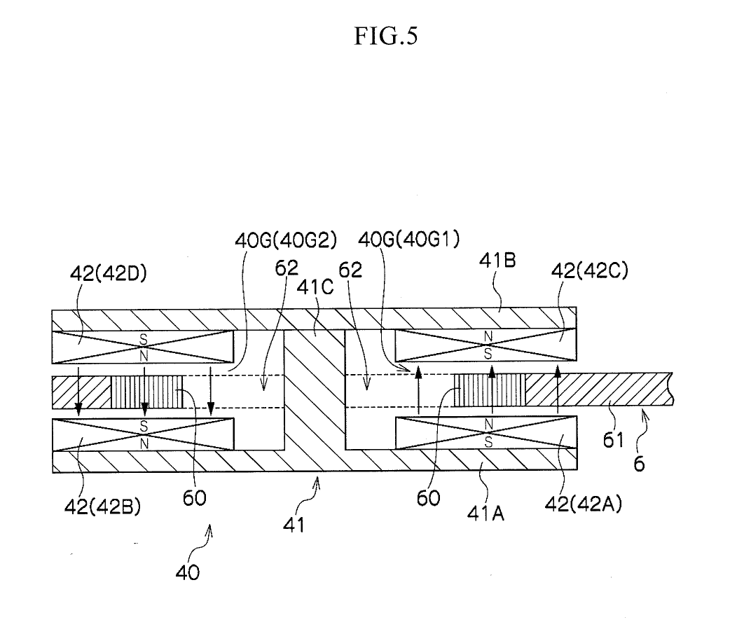

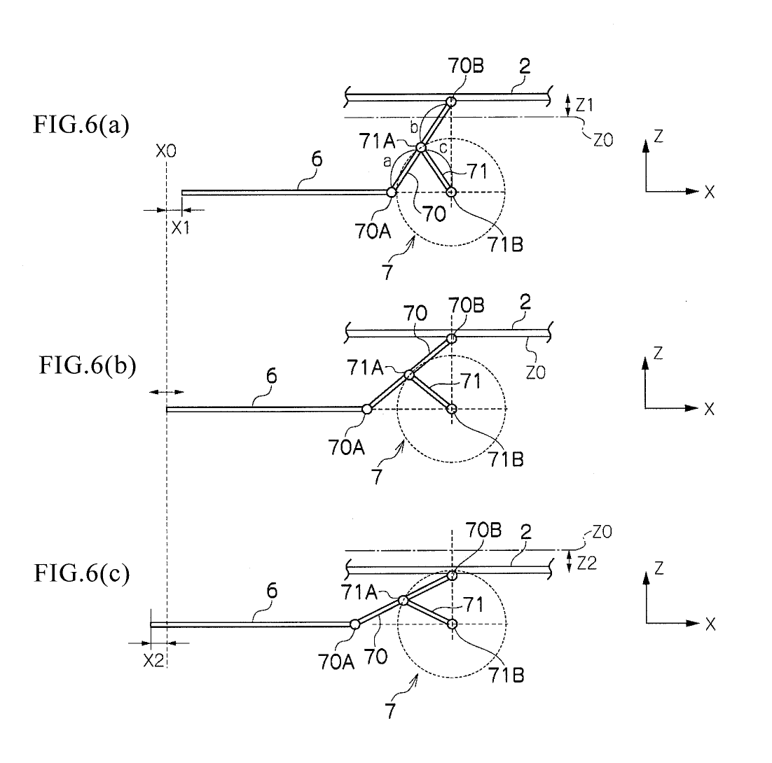

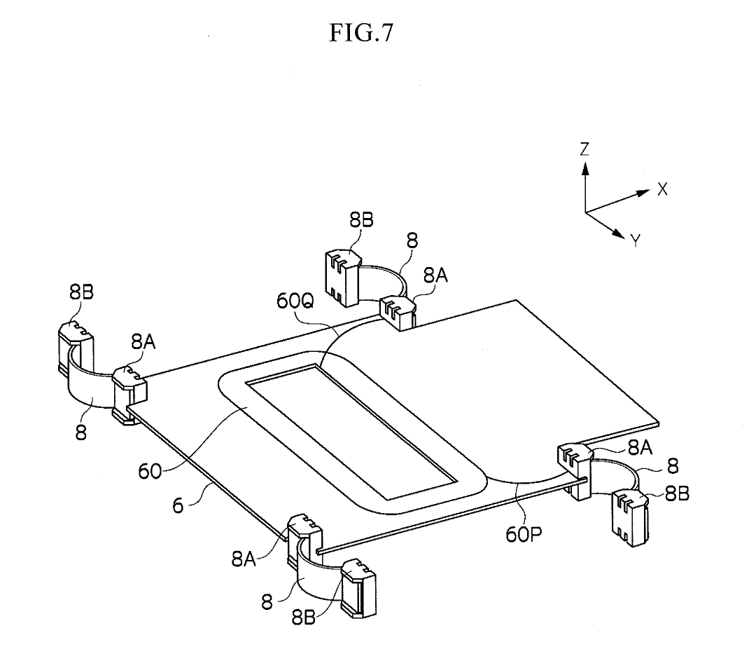

Hereinafter, an embodiment according to the present invention is specifically described with reference to the drawings. FIGS. 2 to 9 are views illustrating a basic configuration of a speaker device according to an embodiment of the present invention. FIG. 2(a) is a plan view (diaphragm is represented by imaginary line and a state except the diaphragm is shown), FIG. 2(b) is a cross-sectional view taken along line A-A of FIG. 2(a) (diaphragm is included), and FIGS. 3 to 9 are views illustrating a driving part (FIG. 3 is an assembly perspective view, FIG. 4 is an exploded perspective view, FIG. 5 is a cross-sectional view, FIG. 6 is a view illustrating an operation of the vibration direction converter part, and FIGS. 7 to 9 are views illustrating a specific example of the holding body of the voice coil). In the following description, the sound emission direction (SD) is defined as Z axial direction, the longitudinal direction of the speaker device is defined as X axial direction orthogonally to the Z axial direction, and the direction orthogonally to the Z axial direction and the X axial direction is defined as Y axial direction.

A speaker device 1 according to an embodiment of the present invention includes a diaphragm 2, a static part 100 vibratably supporting the diaphragm 2 in the vibration direction, and a driving part 4 provided at the static part 100, vibrating the diaphragm 2 upon the audio signal. The static part 100 is a collective term of component supporting vibration of the diaphragm 2 and the driving part 4, etc. The static part 100 corresponds to a combination of a frame 3, a yoke part functioning as the frame 3 as referred to below, and an attachment unit, etc. The static part 100 may not be completely static in itself. The whole part may vibrate affected by vibration of the driving part 4 or by other force. The outer periphery of the diaphragm 2 is supported by an outer periphery edge part 3A of the frame 3 as the static part 100 via an edge 5. The function of the edge 5 is to restrict the vibration direction of the diaphragm 2 basically only in Z axial direction. When the audio signal is applied to the driving part 4, the driving part 4 is driven and the vibration generated by the driving part 4 is applied to the diaphragm 2.

The driving part 4 includes a magnetic circuit 40, a voice coil 60, and a vibration direction converter part 7. The voice coil 60 vibrates in one axis direction along a magnetic gap 40G of the magnetic circuit 40, and the vibration direction converter part 7 converts the vibration direction and transmits the vibration to the diaphragm 2. In the example shown in the drawings, the voice coil 60 vibrates in the X axial direction, and the diaphragm 2 is arranged vibratably in the Z axial direction orthogonally to the X axial direction. The vibration direction converter part 7 converts the vibration of the voice coil 60 in the X axial direction to its own changing angle slantwise to the X axial direction, and thereby vibrating the diaphragm 2 in the Z axial direction.

The magnetic circuit 40 forms the magnetic gap 40G in a different direction (for example, X axial direction) than the vibration direction of the diaphragm 2 (for example, Z axial direction). In the example shown in the drawings, the magnetic gap 40G is formed in a direction orthogonally to the vibration direction of the diaphragm 2. However, the direction of the magnetic gap 40G is not limited to the above direction, it may be formed in a direction at any given angle with respect to the vibration direction of the diaphragm 2.

The voice coil 60 is formed in a tabular plate shape with a wound lead wire to which the audio signal is applied. The voice coil 60 is vibratably arranged at the static part 100 directly or via a voice coil support part 6. The vibration direction of the voice coil support part 6 is restricted linearly by a holding part (damper) 8, and is allowed to move only along the magnetic gap 40G. When the audio signal is inputted to the voice coil 60, a Lorentz force is exerted on the voice coil 60 in the magnetic gap 40G, and the voice coil support part 6 vibrates together with the voice coil 60.

The vibration direction converter part 7 converts the vibration direction of the voice coil 60 and transmits the vibration to the diaphragm 2. The vibration direction converter part 7 includes an after-mentioned rigid link part angle-variably and obliquely arranged between the voice coil 60 or the voice coil support part 6 and the diaphragm 2, and a joint part formed at both ends of the link part, and converts the angle of a link part (first link part) 70 formed between the voice coil support part 6 and the diaphragm 2 in response to the vibration of the voice coil support part 6 and the reaction force exerted from the static part (frame 3 in this embodiment).

The holding part 8 holds the voice coil 60 or the voice coil support part 6 at the frame 3 as the static part 100 such that the voice coil 60 vibrates linearly. In this embodiment, the holding part 8 forms a pathway for transmitting the audio signal to the voice coil 60 such that the audio signal inputted to an audio signal input terminal 9 provided at the frame 3 as the static part 100, is inputted to the voice coil 60 via the holding part 8.

According to this embodiment of the present invention as described above, for example, the audio signal is transmitted from an audio signal source to the audio signal input terminal 9 arranged at the frame 3, and then the audio signal is inputted to the voice coil 60 from the audio signal input terminal 9 via the holding part 8. Upon the audio signal being received, the voice coil 60 or the voice coil support part 6 vibrates along the magnetic gap 40G formed in a different direction than the vibration direction allowed for the diaphragm 2. This vibration is then converted by the vibration direction converter part 7 and is transmitted to the diaphragm 2, thereby the diaphragm 2 is vibrated and a sound is emitted in response to the audio signal in the sound emission direction SD.

At this time, since the direction of the magnetic gap 40G is configured to cross the vibration direction of the diaphragm 2 and the thickness direction of the speaker device 1, an increase of the driving force of the magnetic circuit 40 or the vibration stroke of the voice coil support part 6 has directly little effect on the size of the speaker device 1 in the thickness direction (Z-axis direction). Accordingly, it becomes possible to make the speaker device in a thin shape while enabling a large volume. Further, it is structurally possible to make the speaker device 1 thinner than the vibration stroke (displacement) of the voice coil support part 6, thus the structure facilitates to produce a thin speaker device.

Further, since the vibration direction converter part 7 is configured to convert the vibration direction of the voice coil support part 6 and transmit the vibration to the diaphragm 2 through a mechanical link body, the transmission efficiency of the vibration is high. Furthermore, since the angle conversion of the link part 70 is performed upon receiving the reaction force from the frame 3 as the stationary part against the vibration of the voice coil support part 6, the vibration of the voice coil support part 6 can be more securely transmitted to the diaphragm 2. This will enable the speaker device 1 to attain good reproduction efficiency, and in particular it will be possible to obtain good reproduction characteristic in high-tone range by securely transmitting the vibration of the voice coil 60 to the diaphragm 2.

Also, since the audio signal inputted to the audio signal input terminal 9 provided at the frame 3 as the static part 100 is inputted to the voice coil 60 via the holding part 8, a lead wire electrically connecting the voice coil 60 to the audio signal input terminal 9 can be prevented from having an adverse effect on the vibration of the voice coil 60 due to the vibration of the lead wire along with the vibration of the voice coil 60. Further, since no space is required for an extra length of the above lead wire, a space inside the frame 3 can be saved, and thus an overall speaker device can be made compact and thin.

Hereinafter, each component of the speaker device 1 according to this embodiment is described in detail.

### [Static Part 100 (Frame 3)]

The static part 100 vibratably supports the diaphragm 2 in the vibration direction and supports the driving part 4 therein. The frame 3 as the static part 100 supports part of the link body of the vibration direction converter part 7 and applies a reaction force from the frame 3 in response to action of the link body. The above-mentioned frame 3 preferably includes a planarly shaped bottom face 31A.

Also, the frame 3 is the static part 100 arranged in static state with respect to the voice coil 60 or the voice coil support part 6. The static part 100 does not intend to be completely static, for example, it may be static enough to support the diaphragm 2. Vibration generated when driving the speaker device 1 may be transmitted to the static part 100, thereby causing vibration in the overall static part 100. Further, since the static part 100 may be arranged mechanically together with the magnetic circuit 40 described below and the frame 3 is supported by the magnetic circuit 40, thus the frame 3 may be the static part 100. The static part 100 may correspond to the magnetic circuit 40 itself, the component member of the magnetic circuit 40, or the member supported by the magnetic circuit 40.

When frame 3 shown in FIG. 2 is viewed from the sound emission direction (SD), the planar shape is formed in a rectangular shape and the cross-sectional shape is formed in a concave shape. As shown in the drawing, the frame 3 specifically includes a bottom plate part 31 with planarly rectangular shape and a rectangular shaped tubular part 32 standing from the outer periphery part of the bottom plate part 31 in the sound emission direction (SD), and an opening part 30 is formed at the upper side. Further, the magnetic circuit 40 is arranged on the bottom plate part 31 and the outer periphery part of an edge 5 is connected to the upper end part of the tubular part 32 with adhesive, etc. The diaphragm 2 supported by the edge 5, is arranged at the opening part 30. In the example shown in the drawing, in the upper end part of the tubular part 32 the tubular part includes a flat outer periphery edge part 3A extending inwardly, and the edge 5 is connected to the outer periphery edge part 3A. For example, a public material such as resin, metal, etc. can be adopted as a material forming the frame 3. Instead of using the frame 3, an after-mentioned yoke part 41 constituting the magnetic circuit 4 may be configured to include the same shape as the frame 3 so as to support the edge 5.

Further, as shown in FIG. 2(b), the frame 3 includes a hole part 33 formed, for example at the side face part or the bottom face part. For example, the hole part 33 functions as a vent hole. For example, if no vent hole is provided, air within the space enclosed by the diaphragm 2 and the frame 3 has a spring property according to the vibration of the diaphragm 2 when the speaker is driven. As a result, this may suppress the vibration of the diaphragm 2. In contrast, in the example shown in the drawing, since the hole part 33 is provided, such a suppression of the vibration applied to the diaphragm 2 may be avoided. In addition, the hole part 33 may function to release heat from the magnetic circuit 40 or the voice coil 60. Furthermore, the frame 3 is provided with the audio signal input terminal 9. For example, the audio signal input terminal 9 is connected to a signal line electrically connecting to the audio signal source such as an amplifier, an equalizer, a tuner, a broadcasting receiver, a television, etc., which is located outside the speaker device.

### [Diaphragm 2]

The diaphragm 2 is vibratably supported by the frame 3 in the vibration direction (Z-axis direction), as shown in FIGS. 2(b). The diaphragm 2 emits a sound wave in the sound emission direction (SD) when the speaker is driven. The diaphragm 2 is supported by the frame 3 through the edge 5, and movements in directions other than the vibration direction, specifically in the X or Y direction, are restrained by the edge 5. The edge 5 and the diaphragm 2 may be integrally formed.

The diaphragm 2 may be made of, for example, a resin, a metal, a paper, a ceramic, or a composite material. The diaphragm 2 preferably has rigidity for example. The diaphragm 2 may be formed in a predetermined shape such as a plate shape, a dome shape, a cone shape, and so on. In the example shown in the drawing, the diaphragm 2 is formed in a plate shape, and is supported along the planar bottom face 31A of the frame 3. The diaphragm 2 formed in a planar shape is particularly preferable for the embodiment of the present invention which has a problem to be solved in realizing a thin speaker device. Also, the shape of the diaphragm 2 as viewed from the sound emission direction (SD) (planar shape) is formed in a predetermined shape such as a rectangular, elliptical, circular, polygonal shape and so on. In the drawings, the planar shape of the diaphragm 2 is formed in a rectangular shape.

Since the diaphragm 2 is vibratably supported by the frame 3 and the space enclosed by the diaphragm 2 and the frame 3 at the back side (opposite to the sound emission direction) of the diaphragm 2 is blocked off in the sound emission direction, it is possible to suppress the emission toward the sound emission direction of sound waves from the back of the diaphragm 2.

### [Edge 5]

The edge 5 is arranged between the diaphragm 2 and the frame 3, and the inner periphery thereof supports the outer periphery of the diaphragm 2 and also holds the diaphragm 2 in a predetermined position by joining the outer periphery to the frame 3. Specifically, the edge 5 supports the diaphragm 2 vibratably in the vibration direction (Z-axis direction) and restrains a vibration in a direction perpendicular to the vibration direction. The edge 5 shown in the drawing is formed in a ring shape (annular shape) as viewed from the sound emission direction. As shown in FIG. 2(b), the edge 5 has a predetermined cross-sectional shape, such as convex, concave, or corrugated shape. In this embodiment, the edge 5 is formed in a concave shape toward the sound emission direction, but not limited thereto. The edge 5 may be formed in a convex shape in the sound emission direction. The edge 5 may be made of, for example, leather, a fabric, rubber, a resin, or each of which is sealed with a filler or rubber, otherwise a member of rubber or a resin formed into a predetermined shape, or the like.

### [Magnetic Gap 40]

The magnetic circuit 40 is arranged in the frame 3. The magnetic circuit 40 shown in the drawing is housed in the frame 3 as shown in FIG. 2(b), and the magnetic gap 40G is formed along the planar bottom face 31A of the frame 3. For example, an inner-magnet type magnetic circuit or an outer-magnet type magnetic circuit may be used as the magnetic circuit 40.

As a specific structure, the magnetic circuit 40 includes a yoke 41 and a magnet 42 as shown in FIGS. 4 to 5. The magnetic circuit 40 shown in the drawing includes a plurality of magnets 42A to 42D. In the magnetic circuit 40, the magnets 42 are provided on both sides of the magnetic gap 40G in the magnetic field direction. For example, the magnetic gap 40G is formed along the X-axis direction such that the voice coil 60 can move within a predetermined range along the X-axis direction.

The yoke 41 includes a lower flat part 41A, an upper flat part 41B, and a support 41C. The lower flat part 41A and the upper flat part 41B are arranged substantially parallel to each other with a predetermined interval between them, and the support 41C is formed in the center such that it extends in a substantially perpendicular direction with respect to the lower flat part 41A and the upper flat part 41B.

When an audio signal (current) flows in the voice coil 60 in the magnetic field of the magnetic gap 4G, the Lorentz force is developed in a direction perpendicular to each of the magnetic field direction and the electric current direction according to the Fleming's left-hand rule. In the speaker device 1 according to this embodiment, the voice coil 60 and the magnetic circuit 40 are configured such that the Lorentz force is developed in the voice coil 60 in a predetermined direction different from the vibration direction of the diaphragm 2, specifically, in a direction (X-axis direction) perpendicular to the vibration direction of the diaphragm 2 (Z-axis direction) to vibrate the voice coil 60 in the X-axis direction. The magnets 42A to 42D are arranged on the flat parts 41A and 41B. One magnetic gap 40G1 is formed by the magnets 42A and 42C while the other magnetic gap 40G2 is formed by the magnets 42B and 42D. This pair of magnetic gaps 40G1 and 40G2 is planarly formed side by side such that magnetic fields opposite to each other are generated.

The annular voice coil 60 according to this embodiment has a substantially rectangular shape as viewed from the sound emission direction (SD), and is configured to have straight parts 60A and 60C formed in the Y-axis direction and straight parts 60B and 60D formed in the X-axis direction. The straight parts 60A and 60C of the voice coil 60 are arranged in the magnetic gap 40G of the magnetic circuit 40 so as to generate a magnetic field in the Z-axis direction. It is preferable not to apply a magnetic field to the straight parts 60B and 60D of the voice coil 60. Also, even when magnetic fields are applied to the straight parts 60B and 60D, they are applied so that the Lorentz force developed in the straight parts 60B and 60D can cancel each other.

Further, since the voice coil 60 according to this embodiment is formed in a shape of a thin plate, it is possible to make a portion in the magnetic gap 40G comparatively large by increasing the winding number and thereby obtain a comparatively strong driving force when the speaker is driven.

In the magnetic circuit 40 according to this embodiment, a plurality of magnets 42A to 42D are magnetized such that the direction of a magnetic field in the straight part 60A of the voice coil 60 is opposite to the direction of a magnetic field in the straight part 60C as shown in FIG. 5. Also, the voice coil 60 according to this embodiment is configured in an annular shape such that an audio signal flowing in the straight part 60A and an audio signal flowing in the straight part 60C of the voice coil 60 are opposite to each other in direction.

In the speaker device 1 having the above configuration, when an audio signal is inputted to the voice coil 60, the Lorentz forces developed in the straight part 60A and straight part 60C are in the similar direction, and therefore a driving force is twice as strong as in such a configuration that, for example, a magnetic field is applied to only one of the straight parts 60A and 60C. Accordingly, using the magnetic circuit 40 and the voice coil 60 configured as described above, the speaker device 1 can be configured in a comparatively thin shape and also can obtain a comparatively strong driving force.

### [Voice Coil 60 and Voice Coil Support Part 6]

The voice coil support part 6 includes the above-mentioned voice coil 60 and is formed to be movable along a direction different from the vibration direction of the diaphragm 2. In the embodiment shown in the drawing, the voice coil support part 6 is vibratably arranged along the magnetic gap 40G that is formed along the planar bottom face 31A of the frame 3. More specifically, the voice coil support part 6 of this embodiment is formed to be movable only in the X-axis direction and to be restrained in movements in other directions.

Further, the voice coil support part 6 includes the voice coil 60 arranged in the magnetic gap 40G of the magnetic circuit 40, and a planar insulating member 61 in form of extending from the voice coil 60 to outside of the magnetic gap 40G along the moving direction of the voice coil 60. Also, the voice coil support part 6 has an opening 62 and the voice coil 60 is arranged along the outer periphery of the opening 62. Since the voice coil support part 6 as configured above may have such a structure that the voice coil 60 is embedded into the insulating member 61, it is possible to reinforce the strength of the voice coil 60 and thereby reduce the distortion of the voice coil 60.

In this embodiment shown in the drawing, the opening 62 is loosely fitted to the support part 41C of the magnetic circuit 40 and the moving range of the voice coil support part 6 is restrained in this state. Specifically, the opening part 62 is formed in a rectangular shape and the interval between the sides along the moving direction of the voice coil support part 6 is substantially equal to or longer than the width of the support part 41C, and the interval between the sides in a direction perpendicular to the moving direction is relatively long in accordance with the moving range of the voice coil support part 6.

### [Vibration Direction Converter Part 7]

The vibration direction converter part 7 includes a link body to angle-convert a link part (first link part) 70 formed between the voice coil support part 6 and the diaphragm 2 by using the vibration of the voice coil support part 6 and a reaction force received from the frame 3. Specifically, with reference to FIGS. 2 and 3, the vibration direction converter part 7 includes a first link part 70 and a second link part 71. One end of the first link part 70 is a hinge part 70A between the first link part 70 and the voice coil support part 6 and the other end thereof is a hinge part 70B between the first link part 70 and the diaphragm 2. One end of the second link part 71 is a hinge part 71A between the second link part 71 and the middle portion of the first link part 70 while the other end is a hinge part 71B between the second link part 71 and the frame 3. The first link part 70 and the second link part 71 are obliquely arranged in directions different from the vibration direction of the voice coil support part 6 (for example, X-axis direction).

These link parts are a part to form the link body and basically are not flexible (having rigidity). Each of them has hinge parts at its both ends. The hinge parts can be formed by rotatably joining two members or by forming one member as a folding part that is foldable in any given angle. In the embodiment shown in the FIG. 2(b), the hinge part 71B is formed on a supporting part 34 (stationary part) formed protrudingly on the bottom face 31A of the frame 3. Also, instead of the frame 3 the yoke part 41 may be the static part 100 as described below. When the yoke part 41 is the static part 100, the above-mentioned support part 34 is arranged on the yoke part 41.

In the embodiment as shown in FIGS. 2 and 3, the link body is formed by the first link part 70, the second link part 71, and the hinge parts 70A, 70B, 71A and 71B. In this embodiment, the hinge part 71B between the second link part 71 and the frame 3 is not displaceable, while other hinge parts 70A, 70B and 71A are displaceable. Thereby, the link body as the whole is structured to receive a reaction force from the frame 3 at the hinge part 71B. In this link body, when the hinge part 70A moves in the X-axis direction according to the vibration of the voice coil support part 6, the hinge part 70B moves along the Z-axis direction, thus the vibration of the voice coil support part 6 is direction-converted and transmitted to the diaphragm 2.

The vibration direction converter part 7 according to the embodiment of the present invention can be formed by a plate member having a line-shaped folding part and the folding part may be the above-mentioned hinge part of the link body. Specifically, the first link part 70 and the second link part 71 can be formed with the plate members, while the hinge parts 70A, 70B, 71A and 71B of the link body can be formed by the line-shaped folding parts as shown in the drawings. According to this configuration, it is possible to join the first link part 70 to the diaphragm 2 in a line shape, which enables to apply the vibration to the planar diaphragm 2 uniformly along its width direction and vibrate the whole diaphragm 2 substantially in the same phase. In other words, this can suppress occurrence of a divided vibration, making it possible to reproduce a sound particularly in the high-tone range. In addition, each link part has a rigidity, which enables to suppress occurrence of vibrations in an eigen-frequency mode, thus preventing deflection vibration of the link part or the like from adversely affecting the vibration of the diaphragm 2, thereby suppressing deterioration of acoustic characteristic.

The vibration direction converter part 7 according to this embodiment may have a vent hole for example, though not shown in the drawings. The vent hole can reduce local fluctuations of air pressure in the space enclosed by the diaphragm 2 and the frame 3 and prevents the damping of the vibration direction converter part 7 due to air pressure. Further, a through-hole is formed for example on the link part by making the vent hole, which can reduce the weight of the link part and enables reproduction in high-tone range. Reducing the weight of the vibration direction converter part can effectively broaden bandwidth of reproduction characteristic and increase the amplitude of a sound wave and the sound pressure level with respect to a predetermined voice current. In addition, with the vent hole formed at the link part, air pressure (damping force) exerted on the link part can be comparatively decreased.

Further, vibration direction converter part 7 may be constituted by an integral part connected at the folding part. In this case, the vibration direction converter part 7 forming a complex link body can be instantly joined to the voice coil support part 6 or the diaphragm 2, which improves the assembly performance of the speaker device. Furthermore, the vibration direction converter part 7 may be formed integrally with the voice coil support part 6 or the diaphragm 2 as well, for example.

FIG. 6 is a view illustrating an operation of the speaker device 1 according to an embodiment of the present invention. Specifically, FIG. 6(b) is a view illustrating a state of the vibration direction converter part 7 when the diaphragm 2 is placed at a reference position. FIG. 6(a) is a view illustrating a state of the vibration direction converter part 7 when the diaphragm 2 is displaced to the sound emission side with respect to the reference position. FIG. 6(c) is a view illustrating a state of the vibration direction converter part 7 when the diaphragm 2 is displaced to the side opposite to the sound emission side with respect to the reference position.

As described above, the hinge part 71B is the only hinge part that is not displaced, which is supported by the frame 3, thus applying the reaction force from the frame 3 to the link body. Accordingly, when the voice coil support part 6 moves from the reference position X0 by X1 in the X-axis direction, the angles of the first and the second link parts 70 and 71 obliquely arranged in different directions are increased substantially by the same angle as shown in FIG. 6(a), and the hinge part 70B, receiving the reaction force from the frame at the hinge part 71B, securely pushes up the diaphragm 2 from the reference position Z0 by Z1 in the Z-axis direction. Further, when the voice coil support part 6 moves by X2 reversely in the X-axis direction the angles of the first and the second link parts 70 and 71 are decreased substantially by the same angle as shown in FIG. 6(c), and the hinge part 70B, receiving the reaction force from the frame 3 at the hinge part 71B, securely pushes down the diaphragm 2 from the reference position Z0 by Z2 reversely in the Z-axis direction.

The length a of the link part between the hinge parts 70A and 71A, the length b of the link part between the hinge parts 71A and 70B, and the length c of the link part between the hinge parts 71A and 71B are preferably configured to be similar so that the hinge parts 70A and 71B are arranged on a straight line in the moving direction of the voice coil support part 6. This link body is well known as Scott Russell linkage where the hinge parts 70A, 70B and 71B lie on a circumference of a circle having the diameter being the length of the first link part 70 (a+b=2a) and having the center at the hinge part 71A. Namely, the angle defined by the line passing the hinge parts 70A and 71B and the line passing the hinge parts 70B and 71B is always a right angle. Therefore, when the voice coil support part 6 is moved in the X-axis direction, the hinge part 70B between the first link part 70 and the diaphragm 2 always moves in the Z-axis direction that is perpendicular to the X-axis, thus it is possible to convert the vibration direction of the voice coil support part 6 to its perpendicular direction and transmit the vibration to the diaphragm 2.

### [Damper 8]

Damper 8 holds the voice coil support part 6 at a predetermined position within the magnetic gap 40G such that the voice coil support part 6 does not contact the magnetic circuit 40, and also vibratably supports the voice coil support part 6 along the vibration direction (X-axis direction). The damper 8 restrains movements such that the voice coil support part 6 does not move in directions different from the vibrating direction of the voice coil support part 6, for example in the Z or Y-axis direction.

FIGS. 7 to 9 are views illustrating examples of a holding body of the voice coil support part 6 by the holding part 8. For example, the holding part 8 is formed with a conductive metal and is electrically connected to the end part of the voice coil 60 in the side of the voice coil support part 6 or lead wires 60P, 60Q extended from the end part of the voice coil in the side of the voice coil support part, while holding part is electrically connected to the audio signal input terminal 9 at the end part of the holding part in the side of the frame 3. As described above, the holding part 8 itself may be vibrating wire formed with a conductive metal or wire substrate (for example, substrate with linear wire formed thereon).

In the example shown in the drawing, the holding part 8 is a curved plate member, which allows the voice coil support part 6 to deform in one direction in the vibration direction and restricts deformation in the other direction, and holds the voice coil support part 6 substantially symmetrically. In the example shown in FIG. 7, one end of both end parts of the holding part 8 is attached to the voice coil support part 6 by a connecting part 8A, while another end is attached to the frame 3 by the connecting part 8B. The connecting parts 8A and 8B are configured with an insulating body such as resin, etc. The lead wires 60P, 60Q pulled out of the voice coil 60 are electrically connected to the holding part 8 by soldering, etc. and the holding part 8 is electrically connected to the audio signal input terminal 9.

Also, the connecting parts 8A and 8B may be electrical connecting terminals, and the connecting part 8A may be connected to the end part of the voice coil 60 or the lead wires 60P, 60Q pulled out of the end part of the voice coil, while the connecting part 8B may be electrically connected to the audio signal input terminal 9.

Since the lead wire used for a conventional speaker device vibrates when driving the speaker device, it is required that the lead wire is pulled out in a prescribed space to prevent the lead wire from contacting a member constituting the speaker device, for example the frame 3J, which is one of factors inhibiting the speaker device being made thin. In contrast, as shown in FIG. 7, the lead wires 60P, 60Q being formed on the voice coil support part 6, the prescribed space for wiring the lead wires 60P, 60Q is no more required, and thus the speaker device 1 can be made thin.

The connecting part 8B includes a plurality of groove parts for attaching a wire from outside. Another end of the holding part 8 is attached to the connecting part 8B. The connecting part 8B supports the holding part 8 at the frame 3 such that the voice coil support part 6 vibrates basically in the X axial direction. Also, the lead wires 60P, 60Q extend to the conductive holding part 8 and are electrically connected thereto, which prevents the lead wires 60P, 60Q and the holding part 8 from being broken, thereby reliability of the speaker device 1 can be improved.

The holding part 8 as a curved plate member, formed with a conductive metal, allows the voice coil support part 6 to move in the X axial direction with deformation of the holding part 8 and restricts the voice coil support part to move in the Z axial direction with high rigidity of the curved plate member. Accordingly, the voice coil support part 6 is held at prescribed height in the Z axial direction with respect to the frame 3. Also, the holding parts 8 being provided substantially symmetrical, the voice coil support part 6 is balanced with respect to movement in the Y axial direction with the elastic force of the holding part 8, and thus it is held at a prescribed position also in the Y axial direction with respect to the frame 3.

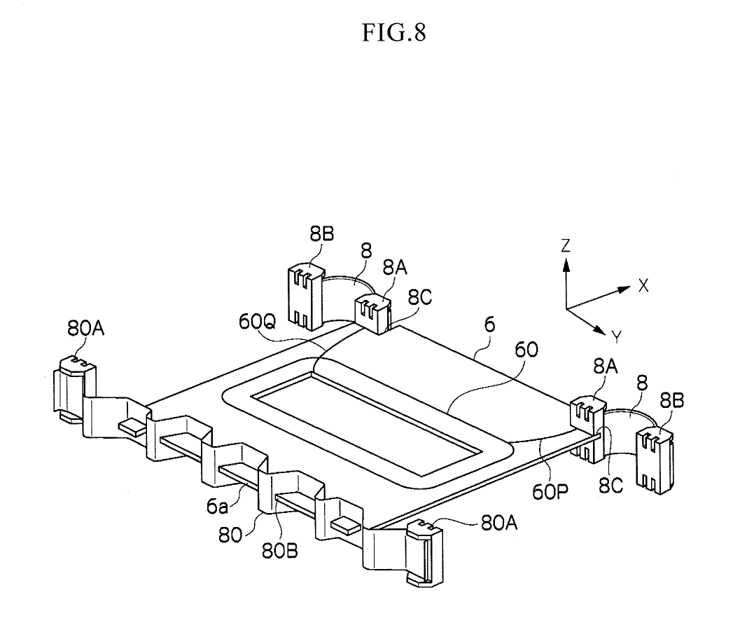

In the example shown in FIG. 8, the right and left holding parts are integrally formed so as to hold a side 6a of end edge of the voice coil support part 6 (the same symbols are applied to the same parts as those in the example shown in FIG. 7 to avoid duplicate description). That is, an integral holding part 80 in which the right and left holding parts are integrally formed, is included. The integral holding part 80 is a plate shape member formed in a corrugated shape including a slit 80B along the side 6a of the voice coil support part 6, and side 6a is held by the slit 80B. Both end parts 80A, 80A of the integral holding part 80 are connected to the frame 3. As such, with rigidity in the Z axial direction of the integral holding part 80 formed in the corrugated shape, deformation or breakage of the voice coil support part 6 is restrained.

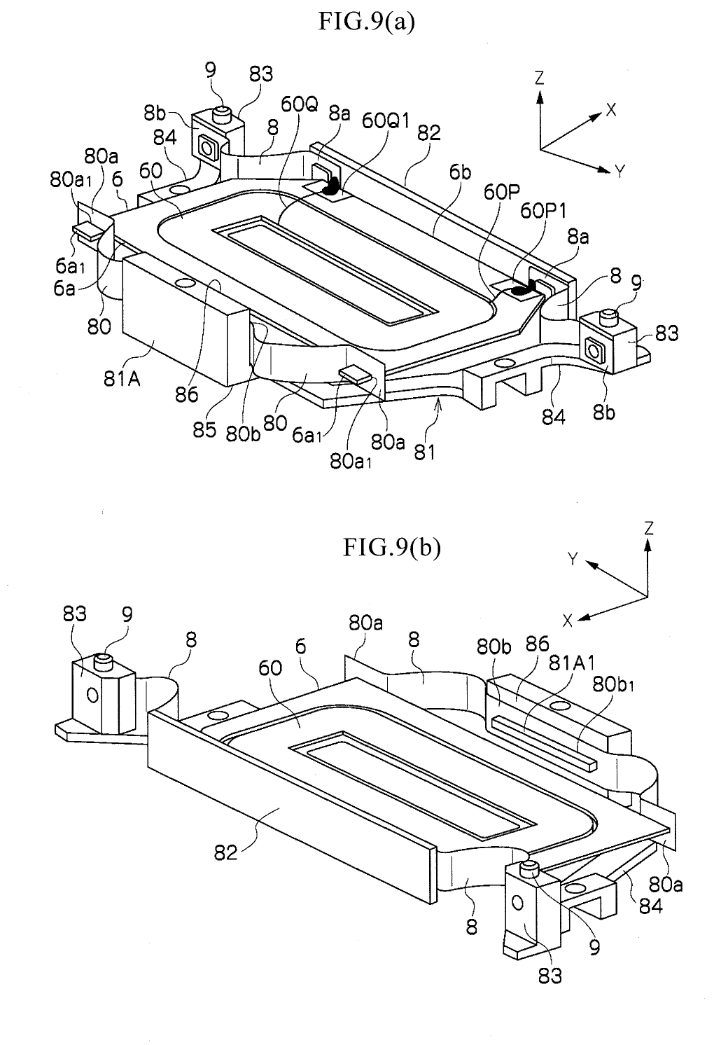

In the example shown in FIG. 9 (FIG. 9(A) is a back perspective view, FIG. 9(B) is a front perspective view), the voice coil support part 6 is attached to the frame via a unit 81, and the voice coil support part 6 is connected to the vibration direction converter part 7 via a connection unit 82. In this example, the connection unit 82 is attached to an end edge part 6b (end edge part in the X axial direction) in the vibration direction of the voice coil support part 6, inner end parts 8a, 8a of the holding parts 8, 8 are attached to both sides of the connection unit 82, and outer end parts 8b, 8b of the holding parts 8, 8 are connected to the audio signal input terminal 9 included at an end edge part in the X axial direction of the attachment unit 81. Further, terminal parts 60P1, 60Q1 of the lead wires 60P, 60Q are formed on the voice coil support part 6, and the terminal part 60P1, 60Q1 are electrically connected to the above-mentioned inner end parts 8a, 8a of the holding part 8.

Further, outer end parts 80a, 80a of the integral holding part 80 are connected to both end parts in the right and left side of the rear part in the X axial direction of the voice coil support part 6, and a central part 80b of the integral holding part 80 is connected to an attachment end part 81A provided at the rear end part in the X axial direction of the attachment unit 81. Specifically, convex shaped projection parts (support part) 6a1, 6a1 are formed toward the integral holding part 80 at both side end parts of another end edge part (side 6a) in the vibration direction of the voice coil support part 6, and slits (supporting counterpart) 80a1, 80a1 are formed at both outer end parts 80a, 80a of the integral holding part 80 so as to support the projection parts 6a1, 6a1, and the projection parts 6a1, Ga1 are inserted into the slits 80a1, 80a1. As such, the attachment unit 81 is configured to be attached to inside the frame 3. With this configuration described above, each part can be integrally attached to the attachment unit 81 and then the integrated attachment unit 81 can be attached to the frame 3, and thus positioning process, etc. can be simplified at the time of manufacturing as well as manufacturing time can be shortened. In addition, the integral holding part 80 is not extended outward in the width direction of the voice coil support part 6, thereby it can be made small in the width direction.

The attachment unit 81 is arranged so as to enclose both side edge parts in the vibration direction of the voice coil support part 6 and another end edge part (side 6a) in the vibration direction of the voice coil support part 6. The end part of the holding part 8 is attached to the connecting parts 83, 83 located outside both side edge parts of the attachment unit 81 in the vibration direction of the voice coil support part 6, and the central part 80b of the integral holding part 80 integrating the right and left holding parts is supported at the attachment end part 81A located outside another end edge part (side 6a) of the attachment unit 81 in the vibration direction of the voice coil support part 6, and thus the voice coil support part 6 is attached to the frame 3 via the attachment unit 81. Also, a convex shaped support part 81A1 is formed projecting toward the integral holding part 80 at the inner side face 86 of the attachment end part 81A, and a slit (support counterpart) 80b1 supported by the support part 81A1 is formed at the center of the integral holding part 80.

The attachment unit 81 is provided at the frame 3 in the lower side of the voice coil support part 6 so as to surround the periphery of the voice coil support part 6. The attachment unit 81 includes the audio signal input terminal 9 to which an external connecting wire is attached, a pole shaped connecting part (pole) 83 to which the outer end part 8b of the holding part 8 is attached, an arm part 84 extending from the connecting part 83 backward in the X axial direction, and the attachment end part 81A supported by the arm part 84. The attachment end part 81A includes a bottom face part 85 supported by the arm part 84, and the inner side face 86 extending from the bottom face part 85 in the Z axial direction. The central part 80b of the integral holding part 80 is attached to the inner side face 86 as described above. Further, attachment end part 81A is cross-sectionally formed substantially in ‘<’ shape.

As described above, the convex shaped support part 80A1 of the attachment end part 81A is inserted into the slit 80b1 of the central part 80b of the integral holding part 80, thereby the integral holding part 80 is held at a given position on the frame 3 while the voice coil support part 6 can be supported with respect to the frame 3. Also, when the integral holding part 80 is provided on the frame, positioning can be made by using the convex shaped support part 80A1 of the attachment end part 81A, thereby the integral holding part 80 can be arranged at the prescribed position on the frame.

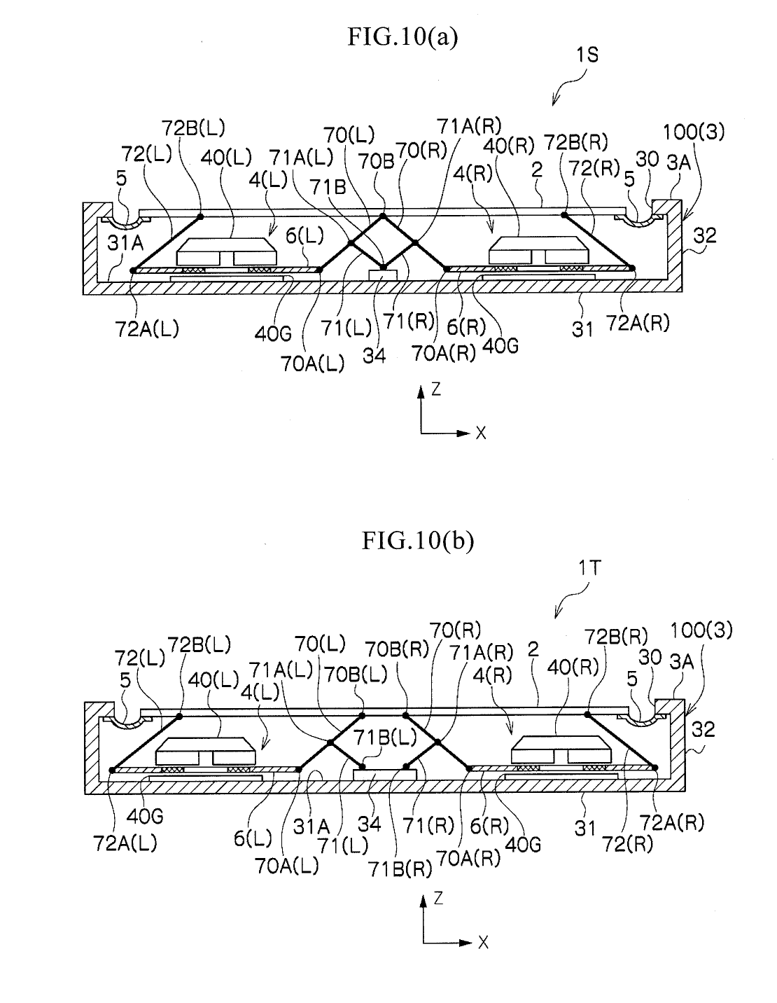

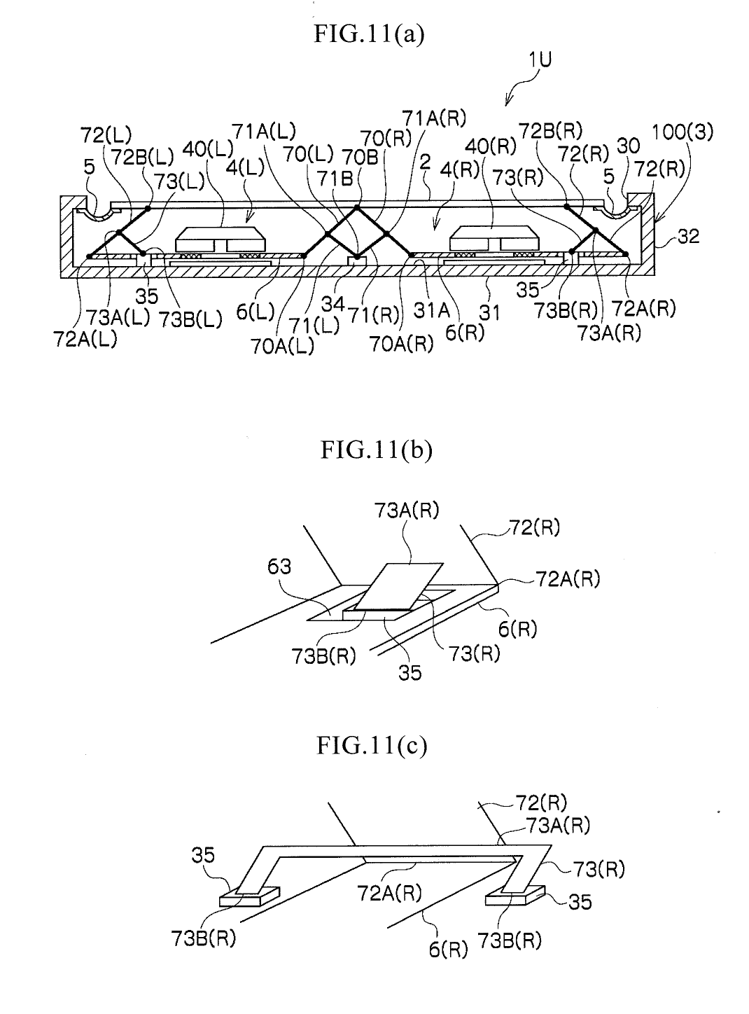

FIGS. 10 to 14 are views illustrating configuration examples of a vibration direction converter part according to an embodiment of the present invention. The same symbols are applied to the same parts as those in the foregoing embodiments to avoid duplicate description. The embodiments shown in FIGS. 10(a) and 10(b) and FIG. 11 have two features respectively. One of them is that the vibration direction converter parts 7 is provided at both end parts of the voice coil support part 6 in the vibration direction of the voice coil support part and parallel links are formed with the link parts of the vibration direction converter parts 7 provided at both end parts of the voice coil support part 6. The other feature is that a pair of driving parts 4 is provided and the vibration direction converter parts 7 are left-right symmetrically arranged in the opposite side.

The speaker devices 1S and 1T as shown in FIGS. 10(a) and 10(b) include a pair of right and left driving parts 4(R) and 4(L) respectively to a single diaphragm 2. The driving parts 4(R) and 4(L) are arranged symmetrically. Namely, the driving part 4(R) includes a magnetic circuit 40(R) and a voice coil support part 6(R). A first link part 70(R) and a second link part 71(R) are provided on the end of the voice coil support part 6(R) on the center side of the diaphragm 2. An outside link part 72 (R) is provided on the outside end of voice coil support part 6(R) with one end as a hinge part 72A(R) between the outside link part 72 (R) and the voice coil support part 6(R) and the other end as a hinge part 72B (R) between the outside link part 72 (R) and the diaphragm 2. Similarly, the driving part 4(L) includes a magnetic circuit 40(L) and a voice coil support part 6(L). A first link part 70(L) and a second link part 71(L) are provided on the end of the voice coil support part 6(L) on the center side of the diaphragm 2. An outside link part 72 (L) is provided on the outside end of voice coil support part 6(L) with one end as a hinge part 72A(L) between the outside the link part 72 (L) and the voice coil support part 6(L) and the other end as a hinge part 72B (L) between the outside link part 72 (L) and the diaphragm 2.

In the vibration direction converter parts provided on the ends of the voice coil support part 6(L) and 6(R) on the center side of the diaphragm 2 respectively in the speaker device 1S as shown in FIG. 10(a), the hinge part 70B of the first link parts 70(L) and 70(R) to the diaphragm 2 forms a common part, while the hinge part 71B of the second link parts 71(0 and 71(R) to the frame 3 forms a common part. In this configuration, a rhombic link body is formed with the hinge parts 70B, 71A(R), 71A(L) and 71B and the vibrations of the voice coil support parts 6(R) and 6(L) as moving close to and away from each other respectively in the X-axis direction are direction-converted to apply the vibration to the diaphragm 2 in the Z-axis direction (sound emission direction). Also, in this case, the hinge part 71B being supported by the frame 3, the link body constituted by the first link parts 70(R) and 70(L), and the second link parts 71(R) and 71(L) receives the reaction force from the frame 3 corresponding to the vibrations of the voice coil support parts 6(R) and 6(L) as moving close to and away from each other, thereby the diaphragm 2 is securely vibrated in the Z-axis direction by this reaction force.

The first link part 70(R) and the outside link part 72(R) provided on both ends of the voice coil support part 6(R) in the vibration direction or the first link part 70(L) and the outside link part 72(L) provided on both ends of the voice coil support part 6(L) in the vibration direction form a set of parallel links respectively. Accordingly, the first link part 70(R) and the outside link 72(R) disposed substantially in parallel to each other, or the first link part 70(L) and the outside link part 72(L) arranged substantially in parallel to each other, perform an angle-conversion substantially with the same angle corresponding to the movements of the voice coil support parts 6(R) and 6(L) in the X-axis direction. Thus, the three hinge parts 70B, 72B(R) and 72B(L) vertically move with the diaphragm 2 being planarly held, enabling a vibration of the diaphragm 2 substantially in the same phase, which can suppress occurrence of divided vibration. At this time, the voice coil support parts 6(R) and 6(L) are required to vibrate substantially in the same phase, and the same amplitude, and in opposite directions to each other.

In the speaker device 1T as shown in FIG. 10(b), the hinge part 70B is divided into hinge parts 70B(R) and 70B(L) which are distantly arranged from each other. Similarly, the hinge part 71B is divided into hinge parts 71B(R) and 71B(L) which are distantly arranged from each other. Other than this, the configuration of the speaker device 1T is the same as the speaker device 1S as shown in FIG. 10(a). Accordingly, the speaker device 1T as shown in FIG. 10(b) exhibits similar functions to the speaker device 1S as shown in FIG. 10(a). However, since the speaker device 1T has hinge parts at four positions 70B(R), 70B(L), 72B(R) and 72B(L) concurrently moving vertically to move diaphragm 2 vertically, thereby enabling to suppress the divided vibration of the diaphragm 2 furthermore.

The embodiment as shown in FIG. 11 is the same as the embodiment shown in FIG. 10 other than the link body of the outside link parts. Although the embodiment shown in FIG. 11 corresponds to the embodiment shown in FIG. 10(a), it may similarly correspond to the embodiment shown in FIG. 10(b) by simply changing the outside link parts. The same symbols are applied to the common parts as those in FIG. 10 not to repeat the same description. FIG. 11(a) is a sectional view of the whole device, and FIGS. 11(b) and 11(c) are views illustrating the hinge part between the outside link part and the frame. The outside link part of this speaker device 1U includes first outside link parts 72(R) and 72(L) and second outside link parts 73(R) and 73(L). A pair of substantially symmetrical driving parts 4(R) and 4(L) is provided here too.

Speaker device 1U shown in FIG. 11 includes the first outside link part 72(R) and 72(L) having a hinge part 72A(R) or 72A(L) to the outside portion of the voice coil support parts 6(R) or 6(L) at one end, and a hinge part 72B(R) or 72B(L) to the diaphragm 2 at the other end, and the second outside link part 73(R) and 73(L) having a hinge part 73A(R) or 73A(L) to the middle portion of the first outside link part 72(R) and 72(L) at one end, and a hinge part 73B(R) or 73B(L) to the frame 3 at the other end. In this embodiment, the hinge parts 73B(R) and 73B(L) are supported by the frame 3 through a supporting part 35.

The hinge parts 73B(R) and 73B(L) between the second outside link part 73(R) and 73(L), and the frame 3 are described hereinafter. As shown in FIG. 11(b), the voice coil support part 6(R) has an opening 63 through which the end of the second outside link part 73(R) may be supported by the frame 3 through the supporting part 35, or it may be supported as shown in FIG. 11(c) where the second outside link part 73(R) has its ends formed in a portal shape with its both ends over the voice coil support part 6(R) being supported by the frame 3 through the supporting parts 35. Although the drawing shows only the example of the right side, the left side is similar to the right side. They are configured almost symmetrically.

According to this embodiment, the link body can be formed to receive the reaction force from the frame 3 in the link parts arranged in outer ends of the voice coil support parts 6(R) and 6(L). Accordingly, the first outside link parts 72(R) and 72(L) can be angle-converted by using the reaction force from the frame 3 corresponding to the movement of the voice coil support parts 6(R) and 6(L), thereby securely moving the diaphragm 2 up and down.

Further in this embodiment, since the link body constituted by the first link parts 70(R) and 70(L), and the second link parts 71(R) and 71(L) always receives the reaction force from the frame 3 corresponding to the movement of voice coil support parts 6(R) and 6(L) along the X-axis direction, the vertical movement of the voice coil support parts 6(R) and 6(L) can be suppressed by the reaction force received from the diaphragm 2 when the link body moves the diaphragm up and down (in the Z-axis direction). This enables a smooth vibration of the voice coil support parts 6(R) and 6(L) and a smooth transmission of the vibration to the diaphragm 2.

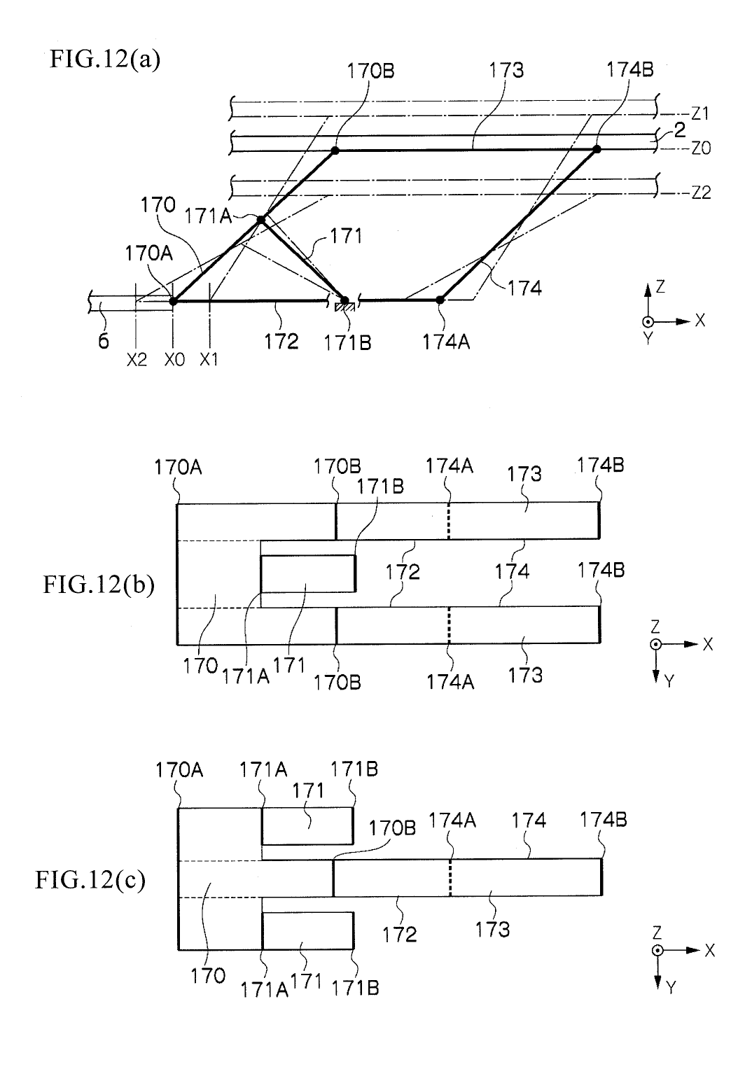

FIG. 12 is a view illustrating a part of the speaker device according to an embodiment of the present invention (FIG. 12(a) is a side view, and FIGS. 12(b) and 12(c) are plan views of the vibration direction converter part). The drawings illustrate another embodiment of the vibration direction converter part where the vibration of the voice coil support part 6 is direction-converted and transmitted to the diaphragm 2.

The vibration direction converter part includes a first link part 170 having a hinge part 170A to the voice coil support part 6 at one end, and a hinge part 170B to the diaphragm 2 at the other end; a second link part 171 having a hinge part 171A to the middle portion of the first link part 170 at one end, and a hinge part 171B to the frame 3 at the other end; a third link part 172 integrally extending from the voice coil support part 6 or formed as a part of the voice coil support part 6; a fourth link part 173 fixed along the diaphragm 2 or formed as a part of the diaphragm 2; and a fifth link part 174 having a hinge part 174A to the end of the third link part 172 at one end, and a hinge part 174B to the fourth link part 173 at the other end. The first link part 170 and the fifth link part 174, and the third link part 172 and the fourth link part 173 form a parallel link respectively.

In this vibration direction converter part, when the hinge part 170A moves from a reference position X0 to X1 in the X-axis direction corresponding to the vibration of the voice coil support part 6, the third link part 172 and the fourth link part 173 forming a parallel link are kept in a parallel state while the first link part 170 and the fifth link part 174 are angle-converted to be raised. At this time, since the hinge part 171B is supported by the frame 3, the angle-conversion of the first link part 170 and the fifth link part 174, upon receiving the reaction force from the frame 3, is securely performed, thereby the displacement of the voice coil support part 6 from position X0 to position X1 is securely converted to the displacement of the diaphragm 2 from position Z0 to position Z1.

Similarly, when the hinge part 170A moves from the reference position X0 to X2 in the X-axis direction, the third link part 172 and the fourth link part 173 forming a parallel link are kept in a parallel state while the first link part 170 and the fifth link part 174 are angle-converted to be laid. At this time, since the hinge part 171B is supported by the frame 3, the angle-conversion of the first link part 170 and the fifth link part 174, upon receiving the reaction force from the frame 3, is securely performed, thereby the displacement of the voice coil support part 6 from position X0 to position X2 is securely converted to the displacement of the diaphragm 2 from position Z0 to position Z2.

According to this embodiment, the vibration of the voice coil support part 6 in the X-axis direction is converted to the vibration in the Z-axis direction at two hinge parts 170B and 174B, and the fourth link part 173 vibrating substantially in the same phase and substantially with the same amplitude. Accordingly, the diaphragm 2 is supported in a broad area and receives the vibration with substantially same phase and amplitude, thus the vibration of the voice coil support part 6 can be transmitted substantially in the same phase to the diaphragm 2 having a planarly broad area.

The link body of the vibration direction converter part shown in FIG. 12(a) can be formed with link parts, each of them having a plate member as shown in FIGS. 12(b) and 12(c). Each of the hinge parts may be made by rotatably joining link parts mutually or foldably connecting or integrally forming the link parts mutually. The plate member preferably has a high rigidity and is light in weight and may be fiber-reinforced plastic film or the like.

In the embodiment as shown in FIG. 12(b), third link parts 172, the fourth link parts 173 and the fifth link parts 174 are parallel arranged in pair respectively. The first link part 170 is formed to be bifurcated and the hinge part 171A to the second link part 171 is formed in the middle portion thereof. The second link part 171 is arranged between the pair of parallel arranged third link parts 172, fourth link parts 173 and fifth link parts 174.

In the embodiment as shown in FIG. 12(c), the third link part 172, the fourth link part 173, and the fifth link part 174 are arranged in a center and the hinge part 171A is disposed in the middle portion of the first link part 170 at both sides, while the second link part 171 is formed at both sides of the first link part 170 having an extending middle portion.

Since the link body is formed with a single plate member, the diaphragm 2 can be vibrated supported by plane, thereby the whole diaphragm 2 can be vibrated substantially in the similar phase furthermore, enabling to suppress the divided vibration. In the embodiment shown in FIG. 12, the speaker device may have a pair of driving parts with the vibration direction converter parts being substantially symmetrically arranged opposite to each other as shown in FIG. 10. In this case, since the diaphragm 2 may be supported at a plurality of points and vibrated substantially in the similar phase, thus enabling to suppress the divided vibration furthermore.

Although the link part can be formed with a plurality of plate shape members, the manufacturing process can be simplified by forming the link part with a single plate member. When forming the link part with a single plate shape member, the link part may be cut out of a single tabular-shaped plate shape member.

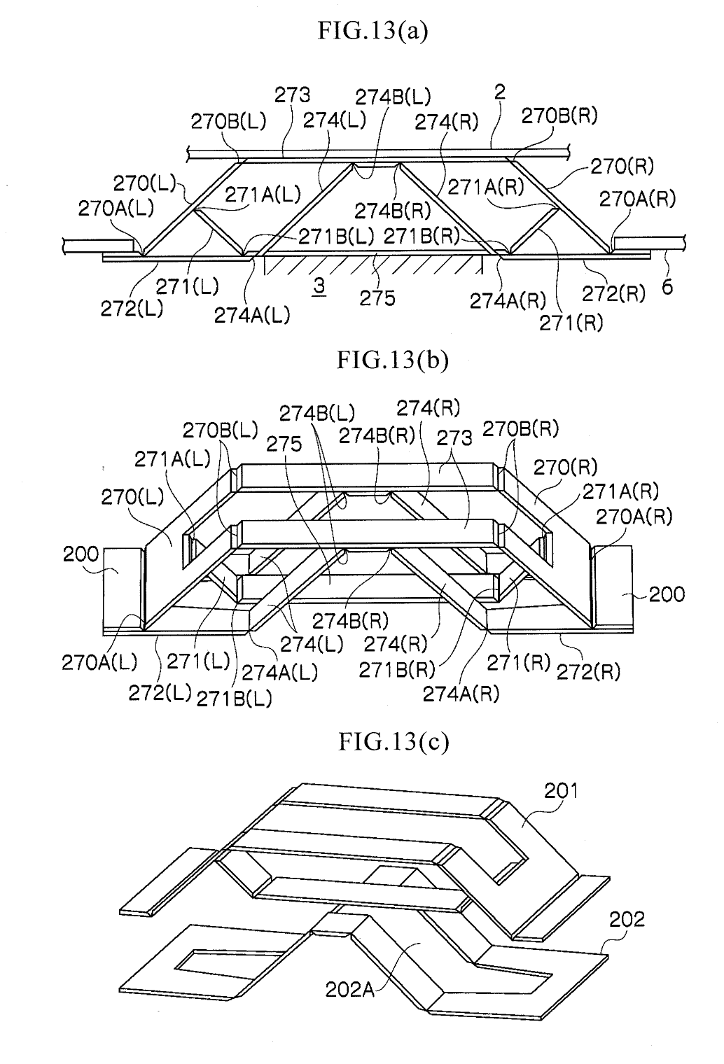

FIG. 13 is a view illustrating a part of the speaker device according to an embodiment of the present invention (FIG. 13 (a) is a side view, FIG. 13 (b) is a perspective view, and FIG. 13 (c) is an exploded perspective view). The drawing shows another embodiment of the vibration direction converter part for direction-converting the vibration of the voice coil support part 6 and transmitting the vibration to the diaphragm 2. This embodiment shows an example where a pair of driving parts is provided with the vibration direction converter parts being parallel arranged opposite to each other substantially symmetrically, while the vibration direction converter parts are formed with integral parts.

The vibration direction converter part according to this embodiment includes a pair of first link parts 270(R) and 270(L) having hinge parts 270A(R) and 270A(L) to the voice coil support part 6 at one end, and having a hinge parts 270B(R) and 270B(L) to the diaphragm 2 at the other end. Also, it includes a pair of second link parts 271(R) and 271(L) having a hinge parts 271A(R) and 271A(L) to the middle portions of the first link parts 270(R) and 270(L) at one end, and having hinge parts 271B(R) and 271B(L) to the frame 3 (sixth link part 275 described below) at the other end. Further The vibration direction converter part includes a pair of third link parts 272(R) and 272(L) integrally extending from the voice coil support part 6 and a fourth link part 273 fixed along the diaphragm 2. Moreover it includes a pair of fifth link parts 274(R) and 274(L) having hinge parts 274A(R) and 274A(L) to the end of the third link parts 272(R) and 272(L) at one end, and having hinge parts 274B(R) and 274B(L) to the fourth link part 273 at the other end. The hinge parts 270B(R) and 270B(L) between the first link part 270 and the diaphragm 2 (the fourth link part 273) are formed at both ends of the fourth link part 273, and the hinge parts 271B(R) and 271B(L) between the second link parts 271(R) and 271(L) and the frame 3 (sixth link part 275 described below) are formed at both ends of a sixth link part 275 having substantially the same length as the fourth link part 273. Further, the first link part 270(R) and the fifth link part 274(R), or the first link part 270(L) and the fifth link part 274(L) form a parallel link respectively, while the third link parts 272(R) and 272(L) and the fourth link part 273 form a parallel link respectively.

This link body of the vibration direction converter part is substantially equivalent to link bodies of the embodiment shown in FIG. 12 almost symmetrically arranged opposite to each other with the hinge parts 174B being distantly arranged. In this embodiment, each link part is formed with a plate member and each hinge part between the link parts is formed by a line-shaped folding part, such that the link parts are integrally formed through the folding part between the link parts. Further, slant surfaces are formed in the proximity of the hinge parts on ends of the link parts. In particular, the slant surface is formed at the side surface opposite to the side surface of the link parts coming to close each other when the link part folds at the hinge part, such that each link part efficiently folds. Specifically, the vibration direction converter part including such a link body is formed with an integral part as shown in FIG. 13(b) and at the ends a connecting part 200 of the voice coil supporting body 6 is formed.

Further, in the vibration direction converter part of this embodiment, the first link parts 270(R) and 270(L), and the fourth link part 273 are formed by folding a whole single plate member forming the link parts in a convex-trapezoid shape, while the second link parts 271(R) and 271(L), and the sixth link part 275 are formed by folding a partly cut portion of this plate member in a concave-trapezoid shape.

Further, the vibration direction converter part is formed by attaching two plate members 201 and 202 to each other as shown in FIG. 13(c). The first link parts 270(R) and 270(L), the second link parts 271(R) and 271(L), the fourth link part 273 and the sixth link part 275 are formed with one plate member 201, while the third link parts 272(R) and 272(L) and the fifth link parts 274(R) and 274(L) are formed with the other plate member 202. And, the third link parts 272(R) and 272(L) and the fifth link parts 274(R) and 274(L) are formed along the first link parts 270(R) and 270(L) and the fourth link part 273, and an opening 202A corresponding to the second link parts 271(R) and 271(L) and the sixth link part 275 is formed in the plate member 202.

In such an embodiment, since the link body of the vibration direction converter part can be formed simply with a single integral part being attached to two voice coil support parts 6 opposite to each other, the assembling process of a speaker device even with a pair of driving parts can be facilitated. Further, the sixth link part 275 enables to always hold the hinge parts 271B(R) and 271B(L) in fixed positions on the frame 3 without particularly fixing them onto the frame 3 corresponding to opposing vibrations of the voice coil support parts 6 (a plurality of the voice coil support parts vibrate in directions opposite to each other), thereby facilitating the incorporation of the vibration direction converter part into the speaker device.

Further, since the right side first link part 270(R) and the third link part 274(R), and the left side first link part 270(L) and the third link part 274(L) form parallel links in the link body, the fourth link part 273 fixed to the diaphragm 2 can be parallel moved stably along the Z-axis direction corresponding to the opposing vibrations of the voice coil support parts 6, thereby enabling to apply a stable vibration to the planar diaphragm 2.

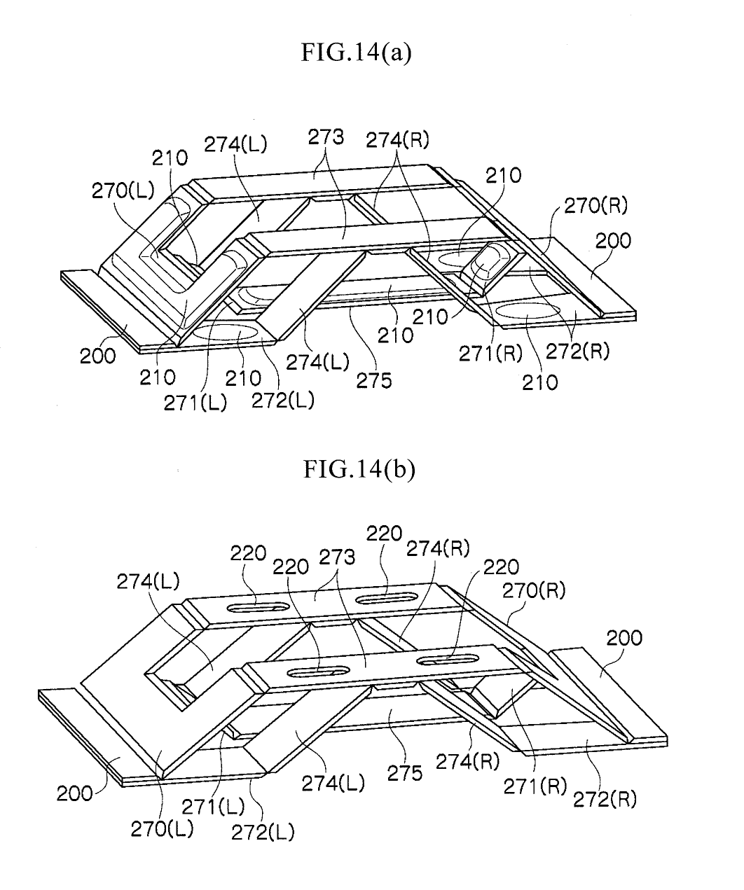

FIG. 14 illustrates an improved embodiment of the embodiment shown in FIG. 13. In this embodiment shown in FIG. 14(a), a convex portion 210 is provided on the link part which is subject to bend by the opposing vibrations of the voice coil support part 6 in order to increase the rigidity. As shown in the drawing, the first link part 270(R) and 270(L), the second link parts 271(R) and 271(L), the third link parts 272(R) and 272(L) and the sixth link part 275 are provided with the convex portion 210 respectively. In addition, in the embodiment shown in FIG. 14(b), an opening 220 is provided in the link part which does not particularly need strength in order to make the vibration direction converter part light in weight. In the drawing, the fourth link part 273 has the openings 220. The vibration direction converter part is effectively formed light in weight to broaden a bandwidth of a reproduction characteristic or increase the amplitude and sound pressure level of a sound wave corresponding to a predetermined voice current.

### Embodiment

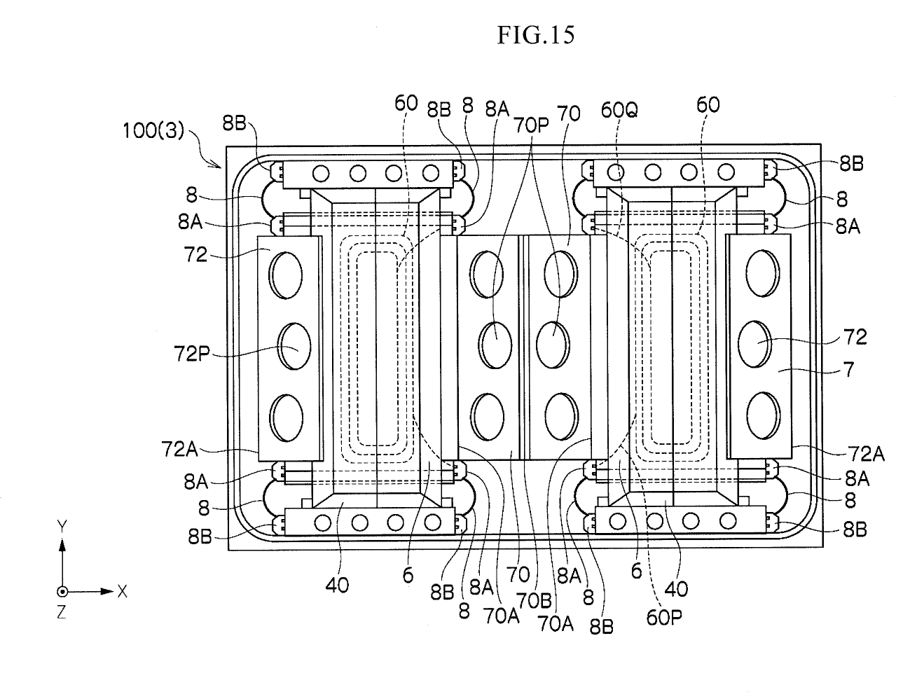

### Embodiments and Application Examples: FIGS. 15 to 17, FIG. 18 and FIGS. 19 to 27

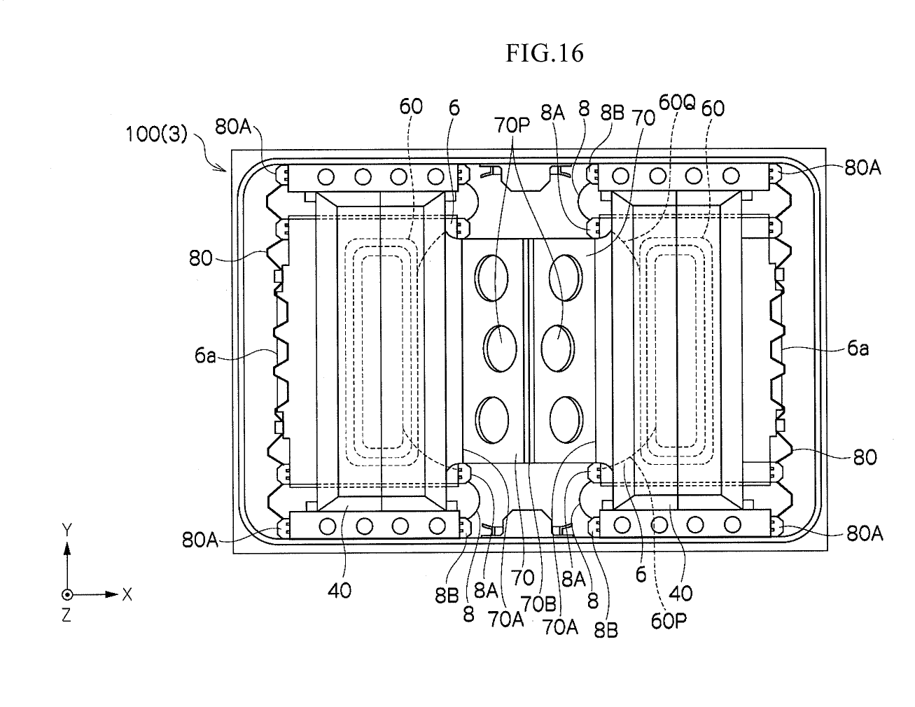

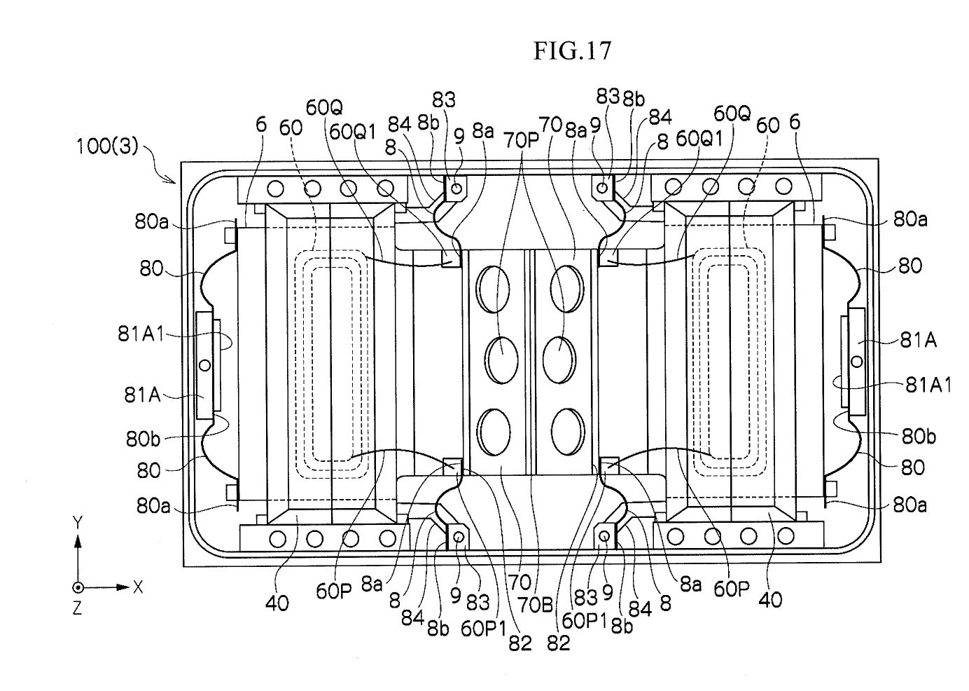

FIGS. 15 to 17 are views illustrating Embodiments according the present invention (plan view except diaphragm). (Repeated descriptions are avoided by applying the same symbols to the same parts as the above-mentioned Embodiments). The example shown in FIG. 15 adopts the holding body of the holding part 8 shown in FIG. 7. The frame 3 as the static part 100 can be a minimum sized frame capable of surrounding the diaphragm (not shown) and supporting the magnetic circuit 40. Connecting parts 8A and 8B are provided at both end parts of the holding part 8. The connecting part 8B is attached to an inner face of the frame 3 and the connecting part 8A is attached to the voice coil support part 6. A lead wire from the voice coil 60 supported by the voice coil support part 6 is connected to an input signal line (not shown) connected from outside of the frame 3 via the connecting part 8A, holding part 8 and connecting part 8B. The example shown in FIG. 16 is the same as the example shown in FIG. 15 except that the holding body of the holding part 8 shown in FIG. 8 is adopted. An integral holding part 80 is attached to a side 6a of the voice coil support part 6, and connecting parts 8A, 8A provided at both end parts of the integral holding part 80 are attached to the frame 3. The example shown in FIG. 17 adopts the holding body shown in FIG. 9, the voice coil support part 6 is attached to the frame 3 via an attachment unit 81, and the voice coil support part 6 and the vibration direction converter part 7 are connected via a connecting unit 82. The attachment unit 81 integrally supports right and left driving parts, and can be integrally attached to the frame 3. In the examples shown in FIGS. 15 to 17, a vent hole 70P or 72P is formed in a link part 70 or 72, such that air resistance can be reduced when the link part 70 or 72 is angle converted in response to vibration of the voice coil support part 6.

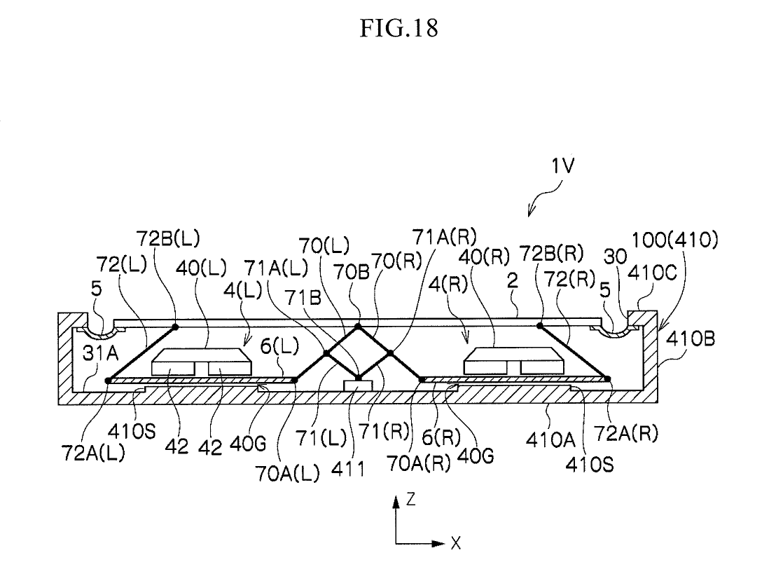

FIG. 18 shows a modified example of the Embodiment shown in FIG. 10(a) (the same symbols are applied to the same parts as those shown in FIG. 10(a) to avoid repeated descriptions). In the speaker device 1V according to this modified example, the member supporting the edge 5 etc. is formed with a yoke part 410 that is a component member of the magnetic circuit 40. The yoke part 410 also can be the static part 100, which is arranged in a static state with respect to the voice coil support part 6. Also, the yoke part 410 includes a bottom face part 410A facing the diaphragm 2 and a side face part 410B surrounding the bottom face part 410A. To form a magnetic gap 40G, a convex shape part 410S is formed at the bottom face part 410A, and the magnetic gap 40G, in which the voice coil support part 6 can slide, is formed between the convex shape part 410S and the magnet 42. Further, a support part 411 is formed on the bottom face part 410A of the yoke part 410. The support part 411 supports the joint part 71B of the second link part 71 and receives a reaction force from the yoke part 410 as the static part 100. The outer edge part of the edge 5 is attached to a top part 410C of the side face part 410B of the yoke part 410, and is supported by the yoke part 410.

Further, the yoke part 410 as the static part 100 does not show a completely static state. For example, the yoke part 410 may be static enough to support the diaphragm 2 and vibration caused by driving the speaker device 1V may be transmitted to generate vibration in the whole static part. Further, the static part 100 may be the attachment unit 81.

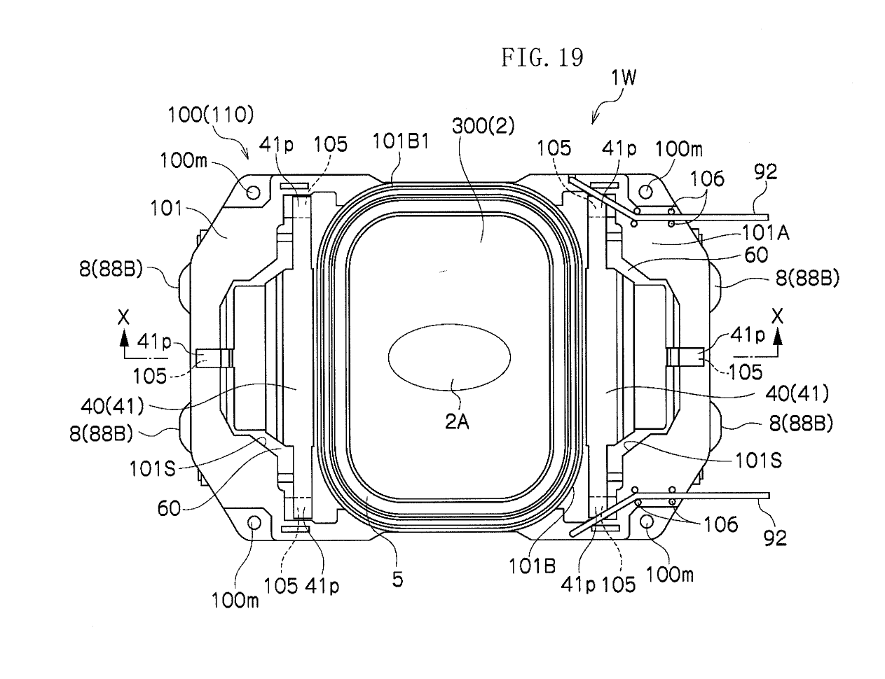

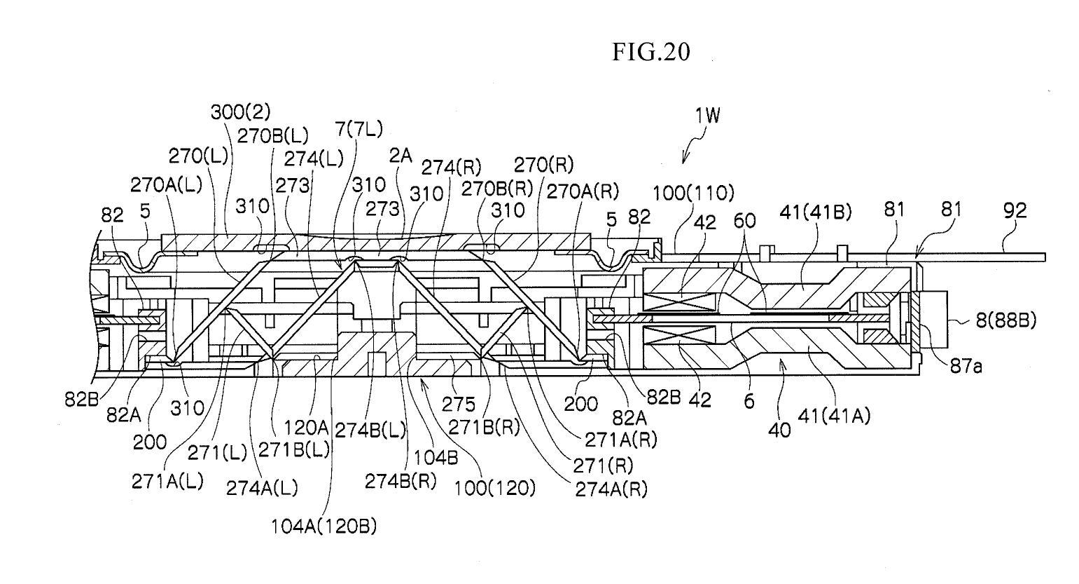

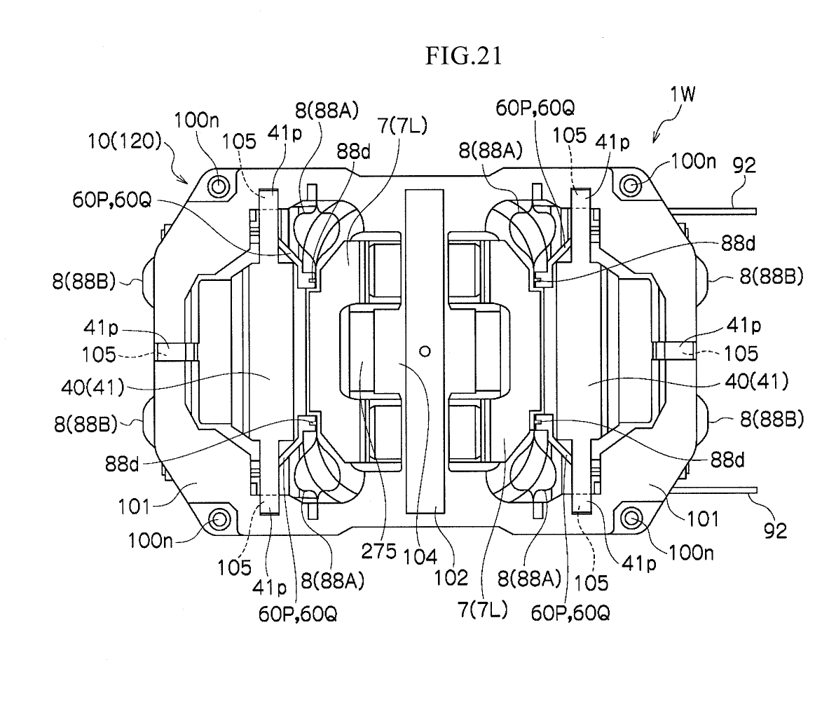

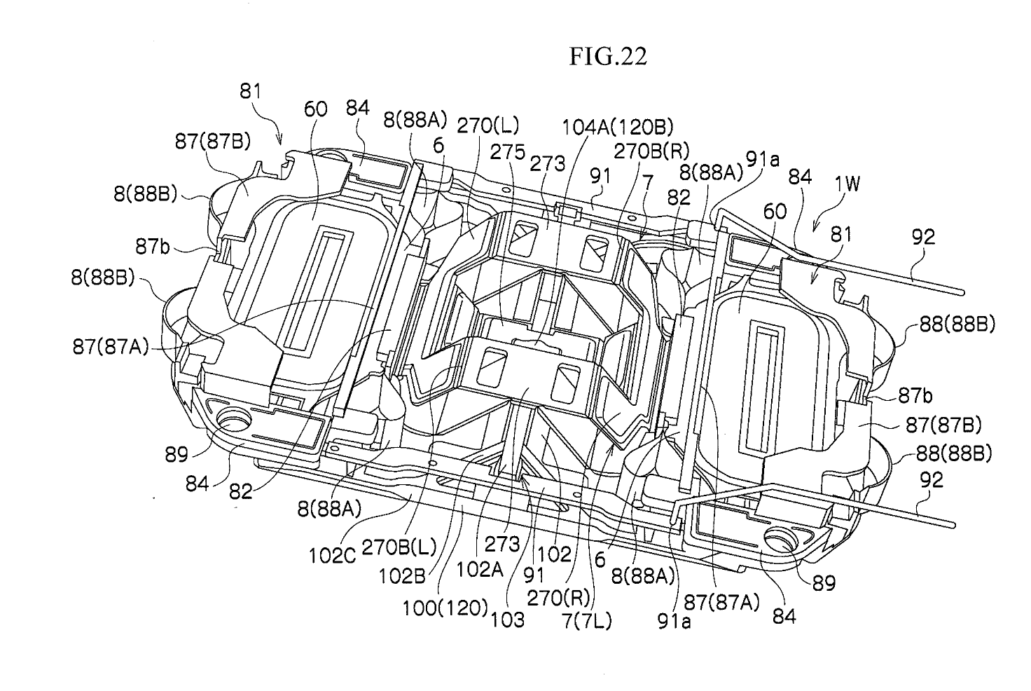

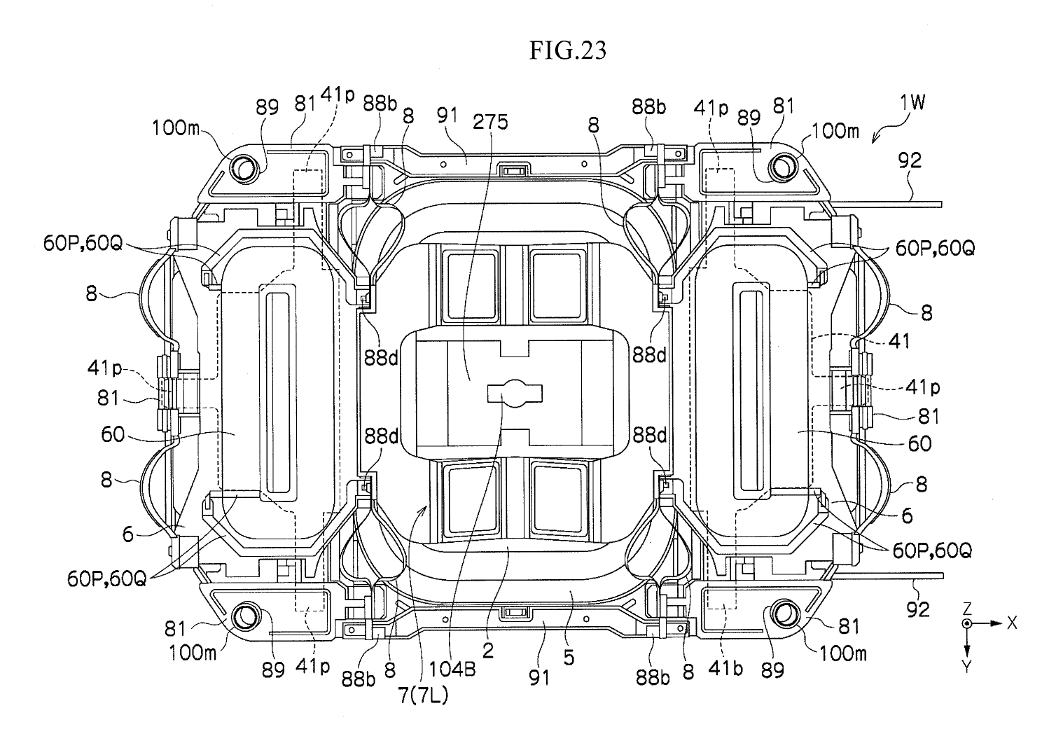

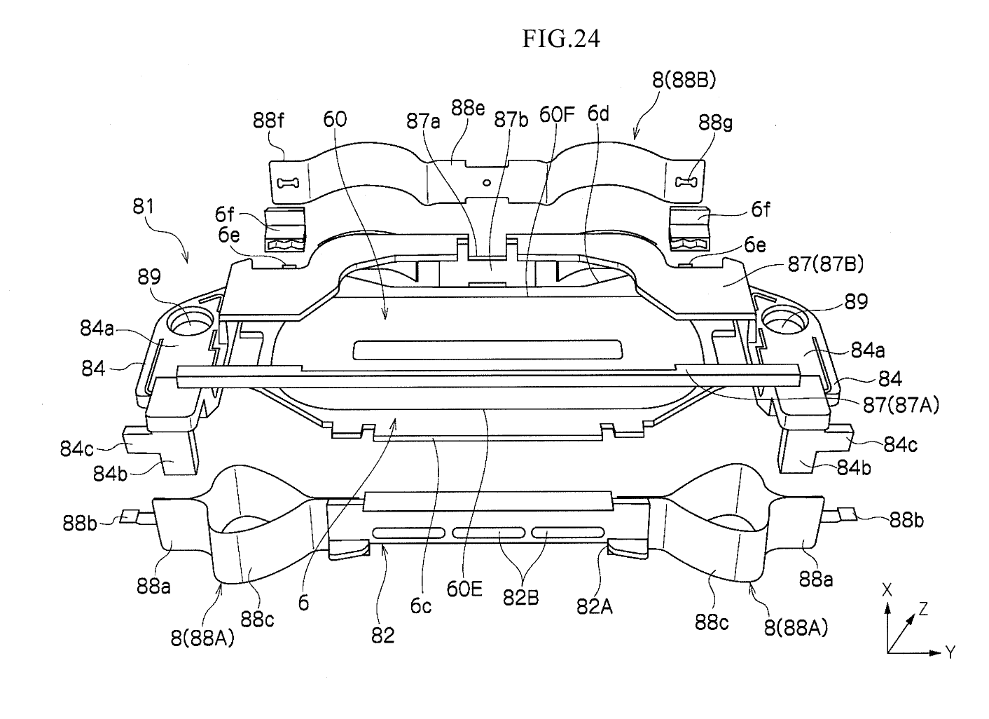

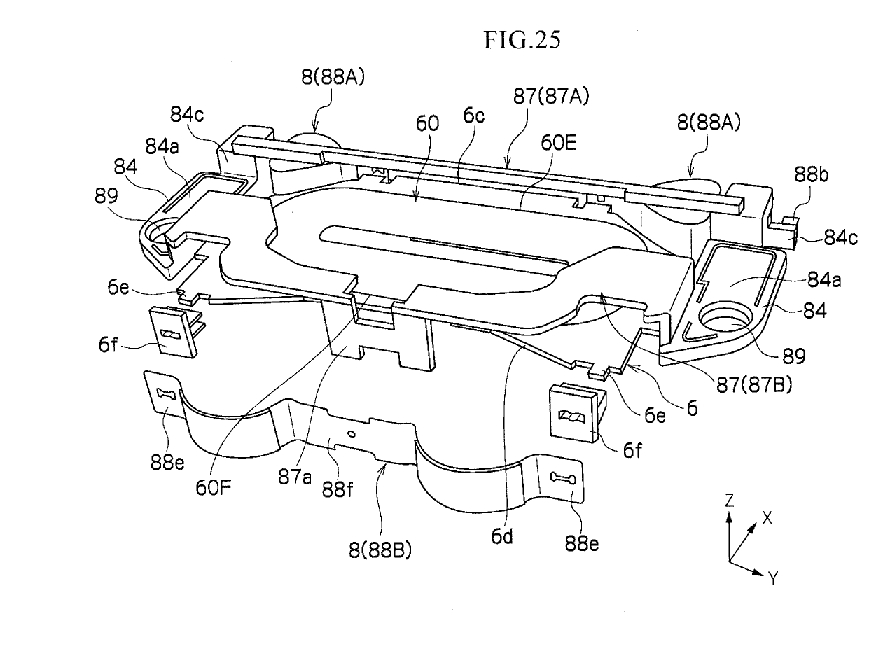

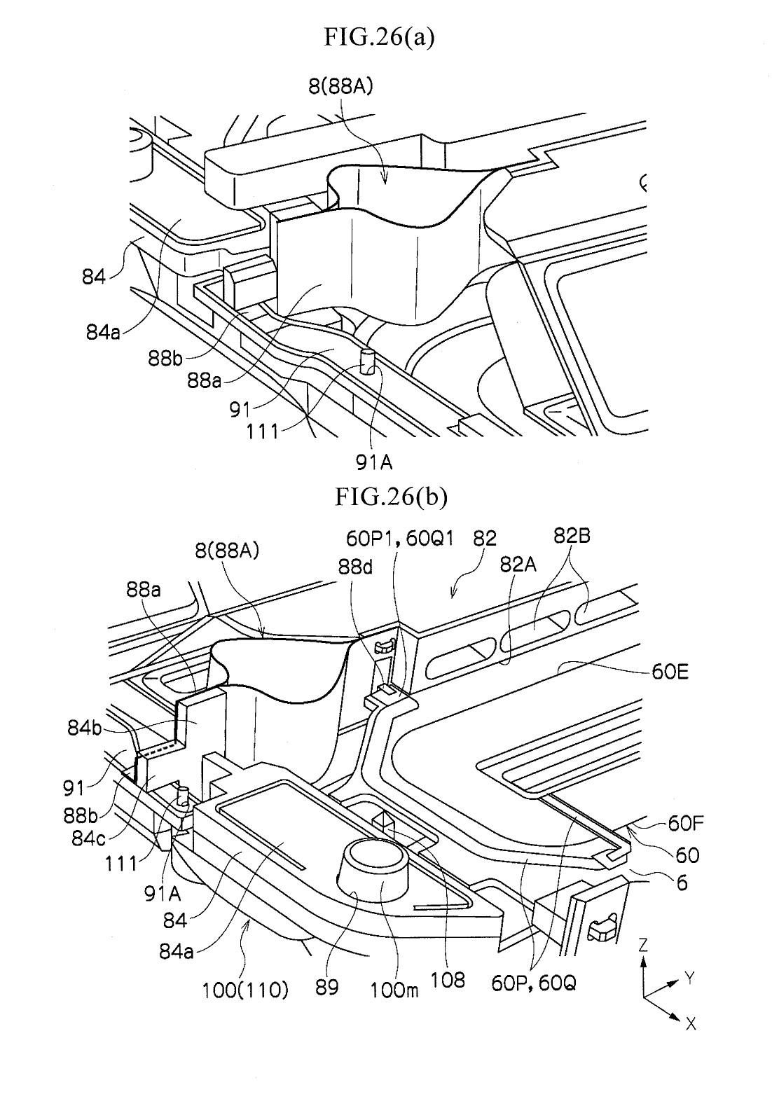

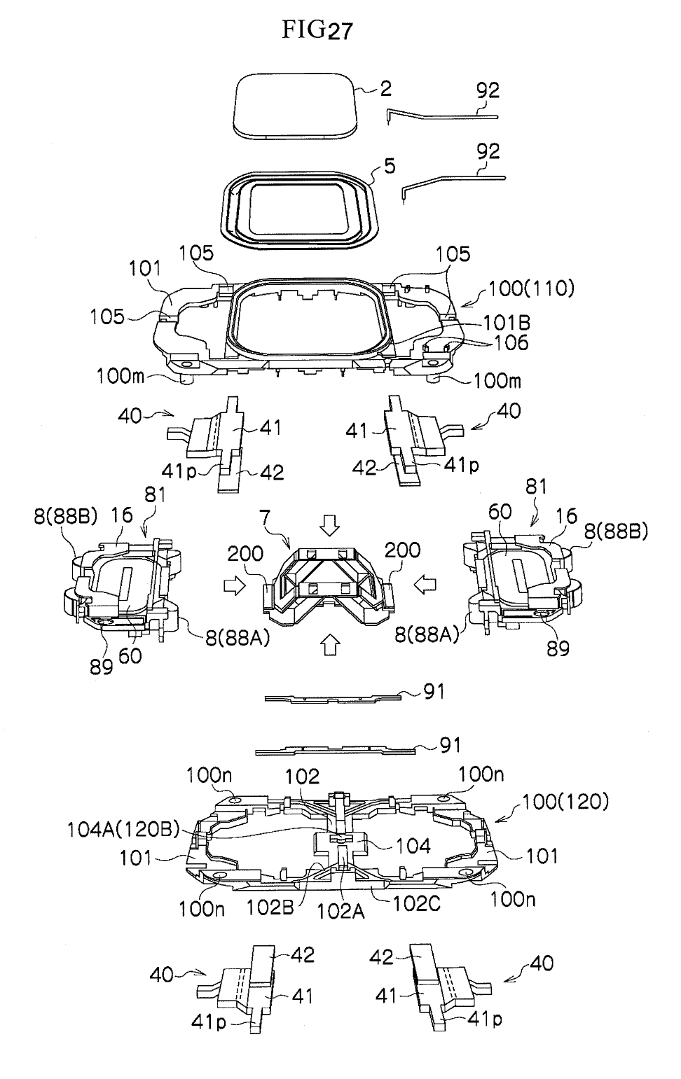

FIGS. 19 to 27 are views illustrating a speaker device 1W according to another embodiment of the present invention (FIG. 19 is a top view, FIG. 20 is a cross-sectional view taken along line X-X, FIG. 21 is a back view, FIG. 22 is a perspective view except a first component member, FIG. 23 is a bottom face view except a second component member, FIGS. 24 and 25 are exploded perspective views of essential parts, FIGS. 26(a) and 26(b) are partially enlarged cross-sectional perspective views of essential parts and FIG. 27 is an exploded perspective view of the whole speaker device). The same symbols are applied to the same parts as those described above to avoid repeated descriptions. The speaker device 1W includes a terminal part member 91 as an audio signal input terminal provided at the above-mentioned static part 100 and a wire 92 for inputting an audio signal inputted from outside.

According to the example shown in FIG. 19, the diaphragm 2 is formed in a rectangular shape viewed from the sound emission direction, and a curved portion 2A having an elliptical outer shape near the central part of the diaphragm and a concave cross-sectional shape, and thus the diaphragm 2 has a predetermined bending rigidity in the vibration direction of the diaphragm 2 and the vibration direction of the voice coil 60. Further, with the concave shaped curved portion 2A formed at the diaphragm 2, density of the curved portion 2A becomes larger than other part of the diaphragm 2 and thereby rigidity may be made comparatively large. Further, when a pair of the vibration direction converter parts 7 are arranged opposite each other, the curved portion 2A is formed between a pair of the hinge parts 274B which are formed between the vibration direction converter part 7 and the diaphragm 2.

Since the diaphragm 2 has rigidity (bending rigidity included) in the vibration direction of the diaphragm, generation of deflection, etc. of the diaphragm 2 may be restrained, and thus generation of difference in phase between sound waves, deterioration of acoustic characteristic, etc. may be restrained. Further, with the curved portion 2A of the diaphragm 2 formed between a pair of the hinges 274B that is formed between the vibration direction converter part 7 and the diaphragm 2, generation of deflection may be restrained.

Further, the diaphragm 2 is formed substantially in a rectangular shape including a short axis extending in the vibration direction of the voice coil 60 and a long axis extending along the direction orthogonal to the vibration direction of the voice coil 60, a reinforcing part (not shown) may be formed in the direction of the long axis or the short axis. The reinforcing part includes a groove part, having, for example, V-shaped cross-section, which is formed linearly, annularly or in a lattice shape in the front face or rear face of the diaphragm 2. For example, filling material such as damping material may be applied to inside of the groove part. As such, with the groove part filled by the filling material, rigidity (bending rigidity included) of the diaphragm 2 may be increased and the peak and dip of sound pressure frequency characteristic of a speaker may be lowered. Further, as another example of the reinforcing part, for example, fiber member made of unwoven fabrics (not shown), etc. may be applied instead of forming the groove part. With the reinforcing part constructed with the fiber member as described above, rigidity (bending rigidity) of the diaphragm 2 may be increased, and thus generation of deformation such as deflection in the diaphragm 2 due to vibration or air resistance transmitted from the vibration direction converter part when the diaphragm 2 vibrates, may be restrained. Further, provided with the reinforcing part, an internal loss of the diaphragm 2 may be improved.

Further, the diaphragm 2 is formed with a first layer constructed with foamed resin including acrylic resin, etc. and a second layer including a fiber member such as a glass fiber, configuring a stacking structure in which the first layer is sandwiched between a pair of the second layers. As a forming material of the diaphragm 2, for example, resin material, metal material, paper material, fiber material, ceramics material, compound material, etc. may be adopted.

The edge 5, vibratably supporting the diaphragm 2 at the frame 3 as the static part 100, is arranged between the diaphragm 2 and the frame 3, and the inner periphery part supports the outer periphery part of the diaphragm 2 while the outer periphery part is connected to the frame 3 directly or via other member, and thus the diaphragm 2 is held at a prescribed position. As other member, elastic member functioning as a packing (including resin member), adhesive resin, etc. are included. More specifically, the edge 5 vibratably supports the diaphragm 2 in the vibration direction (Z-axis direction), and restrains vibration in the direction orthogonal to the vibration direction (Y-axis direction). The edge 5 is formed in a ring shape (annular shape) viewed from the sound emission direction, and the cross-section of the edge 5 is formed in a prescribed shape, for example, a concave shape, convex shape, corrugated shape, etc. in the sound emission direction. As the forming material of the edge 5, conventional material, for example, fur, cloth, rubber, resin, a filler-applied member with a material such as fur, cloth, rubber or resin, rubber member or resin member molded in a prescribed shape, may be adopted. Further, in a part or whole circumference of the edge 5, a projection part projecting from the front face (in the sound emission direction), or from the rear face (in the direction opposite to the sound emission direction) or a concave portion may be formed, rigidity of the edge 5 in a prescribed direction may be increased.

The static part 100 includes the first component member (first frame) 110 arranged in the side of the diaphragm 2 and the second component member (second frame) 120 arranged opposite to the first component member and the driving part 4 is supported and sandwiched between the first component member 110 and the second component member 120. The magnetic circuit 40 includes a pair of magnetic pole members (yoke part 41, magnet 42) that sandwich the voice coil 60 and are arranged near the voice coil 60. These magnetic pole members are separated and supported by the first component member 110 and the second component member 120 respectively. The voice coil 60 is held by the attachment unit 81 via the holding part 8. With the voice coil 60 attached to either one of the first component member 110 or the second component member 120, the voice coil 60 is held at a given position with respect to the static part 100.

The static part 100 includes an outer peripheral frame part 101 surrounding the diaphragm 2 and a bridge part 102 bridging inside of the outer peripheral frame part 101. The bridge part 102 exerts a reaction force on the above link body 7L (vibration direction converter part 7), and has rigidity in the vibration direction of the link body 7L.

As described above, upon vibration of the voice coil 60, the vibration is transmitted to the diaphragm 2 via the link body 7L. At this time, the link body 7L angle converting the link part 270, 271, 274 is subjected to a reaction force exerted by the diaphragm 2. When the link body 7L is subjected to this reaction force, if the static part 100 supporting the link body 7L is deflected, the link body 7L itself vibrates, and thus the link body 7L may transmit unwanted vibration to the link part 51. When the unwanted vibration transmitted to the link part 270, 271, 274 is transmitted to the diaphragm 2, the vibration of the voice coil 60 may not be efficiently transmitted to the diaphragm 2. Accordingly, the bridge part 102, which is a part of the static part 100 supporting the link body 7L, is provided with a function of restraining generation of deflection, and thus unwanted vibration that may be transmitted to the link part and the diaphragm 2 may be restrained. As such, vibration of the voice coil 60 may be efficiently transmitted to the diaphragm 2.

In order that the bridge part 102 supporting the link body 7L may have rigidity against a force exerted by the diaphragm 2 via the link body 7L, compliance of the bridge part 102 is preferably substantially the same or smaller than compliance of the outer peripheral frame part 101 in the vibration direction of the diaphragm 2. More specifically, thickness of the bridge part 102 is preferably substantially the same or larger than thickness in a part of the static part 100 supporting the diaphragm 2 or the magnetic circuit 40.

In the example shown in the drawing, the bridge part 102 provided at the second frame 3C has a first projection part 102A projecting in the direction that the bridge part extends and in the vibration direction of the diaphragm 2. This first projection part 102A includes a rib structure formed in a longitudinal direction of the bridge part 102, which increases bending rigidity of the bridge part 102. Further, a second projection part 102B is formed extending in the direction crossing the first projection part 102A, in the plane of the bridge part 102 facing the diaphragm 2. This second projection part 102B acts as a reinforcing rib at both end portions of the bridge part 102, and rigidly supports the bridge part 102 at the outer peripheral frame part 101 by both end portions.

Further, the bridge part 102 has a third projecting part 102C crossing the first projection part 102A and the second projecting part 102B. The third projecting part 102C is formed in the plane of the static part 100 facing the diaphragm 2, and a reinforcing part 103 having polygonal planar shape is formed with a plurality of the second projection part 102B and the third projecting part 102C.

Further, the first frame 3B includes the outer peripheral frame part 101 of the static part 100 as a first outer peripheral frame part 101A, and includes a second outer peripheral frame part 101B supporting the diaphragm 2 inside the first outer peripheral frame part 101A. An opening inside the second outer peripheral frame part 101B is sealed by the edge 5 and the diaphragm 2. A projection part 101B1 projecting in the sound emission direction is formed at the second outer peripheral frame part 101B by which the diaphragm 2 is supported via the edge 5. With this projection part 101B1, rigidity to support the circumference of the diaphragm 2 is obtained.

The first frame 3B and the second frame 3C configuring the static part 100 are formed in a planar shape having a long axis and a short axis, and the bridge part 102 is formed in the short axis direction. Further, the bridge part 102 may be formed in the long axis direction or in the long and short axis directions, and thus rigidity of the static part 100 may be obtained.

Convex portions 100m are formed at the four corners of the first frame 3B, and concave portions 100n are formed at the four corners of the second frame 3C. The convex portions 100m and the concave portions 100n are fitted such that the first frame 3B and the second frame 3C are coupled. The convex portion 100m may be formed at one of the first frame 3B and the second frame 3C, and the concave portion 100n may be formed at the other one of the first frame 3B and the second frame 3C. The concave portion 100n may be formed to be a hole.

The vibration direction converter part 7 includes a first link part 270 and a second link part 271 as the link body 7L, and one end of the second link part 271 is supported by the first link part 270 and the other end is supported by the bridge part 102. The bridge part 102 supporting the second link part 271 is formed in a tabular shape, and a connecting part 104, where the other end of the second link part 271 and the bridge part 102 are connected, forms a single plane.

With the other end of the second link part 271 fitted in the bridge part 102, the vibration direction converter part 7 and the bridge part 102 are connected. A projection part 104A is formed at the connecting part 104 of the bridge part 102, and a hole 104B in which the projection part 104A is inserted, is formed at the connecting part (sixth link part) 275 integrally formed at the end of the second link part 271 via the hinge part 52.

The projection part 104A of the connecting part 104 in the bridge part 102 acts as a positioning part positioning the vibration direction converter part 7 with respect to the static part 100. The vibration direction converter part 7 is positioned with respect to the static part 100, with the projection part 104A inserted into the hole 104B at the connecting part (sixth link part) 275, which is integrally formed at the end of the second link part 271 via the hinge part 52.

In the condition that the first frame 3B and the second frame 3C as a static part 100 are connected, the second connecting part (fourth link part) 273 of the vibration direction converter part 7 is connected to the rear side of the diaphragm 2 supported by the first frame 3B, and the static connecting part (sixth link part) 275 of the vibration direction converter part 7 is connected to the connecting part 104 formed at the central part of the bridge part 102 in the second frame 3C.

The second connecting part (fourth link part) 273 is a part integrally formed at the end of the first link part 270 via the hinge part 270B, and the end of the first link part 270 and the diaphragm 2 is connected with this second connecting part (fourth link part) 273 connected to the diaphragm 2. A concave portion is formed at the face of the diaphragm 2 in the sound emission side facing the second connecting part (fourth link part) 273, and the diaphragm 2 has rigidity. The static connecting part (sixth link part) 275 is a part integrally formed at the end of the second link part 271 via a hinge part 271B, and the hole 104B is formed at the connecting part (sixth link part) 275. The projection part 104 is inserted into the hole 104B, and thereby the connecting part 104 and the end portion of the second link part 271 are connected.

FIGS. 23 and 24 are exploded perspective views showing attachment of the attachment unit 81 and the holding part 8 shown from a reverse direction. The attachment unit 81 includes a plurality of arm parts 84 arranged along both side edge parts of the voice coil 60, extending in the vibration direction (X axial direction) of the voice coil 60 and a bridge part 87 connecting between the arm parts 84. The arm part 84 supports the holding part 8 connected to the voice coil 60, and forms a flange part 84a supported between the first component member 110 and the second component member 120, which can be the static part 100. The arm part 84 includes a flat connecting part 84b and a projection part 84c projecting from the arm part 84 toward the static part 100.

The bridge part 87 has a shape projecting from the flange part 84a toward the diaphragm 2, or the first component member 110 or the second component member 120 which can be the static part 100, and a predetermined interval is provided between the voice coil 60 and the bridge part 87. Further, a part of the bridge part 87 opposite to the voice coil 60 is arranged at a different height than the voice coil 60. In the example shown in the drawing, the bridge part 87 is shown so as to have a shape projecting toward the diaphragm 2. The bridge part 87, however is not limited to the above configuration, and may be formed so as to have a shape projecting toward the static part 100 as necessary. Further, a plurality of the bridge parts 87 are provided, extending from one arm part 84 to another arm part 84, by passing the yoke part 41 or the magnet 42, being the magnetic pole member of the magnetic circuit 40, and are arranged near both side edge parts 60E and 60F extending in the direction (Y axial direction) intersecting the vibration direction of the voice coil 60. In the example shown in the drawing, one bridge part 87A is provided at one side edge part 6c of the voice coil support part 6, to which the vibration direction converter part 7 is connected, and another bridge part 87B is provided at another side edge part 6d of the voice coil support part 6. Another bridge part 87B includes a connecting part 87a connecting with an second holding part 88B and the another bridge part described below, which is formed in a shape projecting from the flange part 84a toward the diaphragm 2 or the static part 100.

Another side edge part 6d of the voice coil support part 6 opposite to the side of the vibration direction converter part is formed in a concave shape in the side of the voice coil 60. The voice coil support part 6 vibrates in response to vibration of the voice coil 60 and is formed in a planar shape so that contact with the attachment unit 81 is prevented. Specifically, a comparatively large gap is formed between the inner side face 87b of the attachment unit 81 described below and another side edge part 6d of the voice coil support part 6, and the voice coil support part 6 is formed in a planar shape projecting toward the second holding part 8 (88B) as gradually approaching to flat parts 88e at left and right end parts of the second holding part 8 (88B).

For example, the holding part 8 is formed of conductive metal and includes a pair of first holding parts 88A sandwiching the connection unit 82 and attached in the direction (Y axial direction) intersecting the vibration direction of the voice coil 60 and a second holding part 88B integrated in the direction (Y axial direction) intersecting the vibration direction of the voice coil 60 similarly to the example shown in FIG. 9. The first holding part 88A is connected to the arm part 84 and one side edge part 6c of the voice coil support part 6 in the example shown in the drawing, in the side of one side edge part 60E of the voice coil 60, in the proximity of one bridge part 87A. The second holding part 88B is continuously formed from one arm part 84 to another arm part 84, and connected with another side edge 6d of the voice coil support part 6 via a bridge part 87B in the example shown in the drawing in the side of another side edge part 60F of the voice coil 60. Further, the first holding part 88A includes a tabular portion (first face) 88a having a linear cross-sectional shape, a terminal connecting face (second face) 88b projecting from this tabular portion 88a, a curved part 88c continuously formed from the tabular portion 88a and having a curved planar shape, and a connecting face (third face) 88d extending in the direction intersecting the tabular portion 88a.

The tabular portion 88a of the first holding part 88A is connected directly or via other member with the flat connecting part 84b formed at the arm part 84 of the attachment unit 81, etc. and the connection unit 82 is attached to one side edge part 6c of the voice coil support part 6 by fitting. The both end parts of the second holding part 88B are attached to another side edge part 6d of the voice coil support part 6 and the central part of the second holding part 88B is attached to the connecting part 87a of another bridge part 87B. Here, an elastic member such as an adhesive resin and a resin member and a damping member are listed as other materials of the holding part 8. And thus, the attachment unit 81, the voice coil support part 6 and the holding part 8 (the first holding part 88A and the second holding part 88B) can be unitized and incorporated between the first component member 110 and the second component member 120. In addition, the second holding part 88B is arranged within the width of the voice coil support part 6 so that the thickness of the holding body of the voice coil support part 6 does not take up space in the width direction of the voice coil support part 6.

An integral component of the second holding part 88B and the attachment unit 81 are connected via adhesive resin. The tabular portions 88e, 88e formed at left and right end parts of the second holding part 88B are connected to connecting parts 6e, 6e at left and right end parts of another side edge part 6d of the voice coil support part 6 via coupling components 6f, 6f respectively, and a tabular portion 88f formed at the center of the second holding part 88B is connected to a connecting part 87a of the attachment unit 81. Another side edge part 6d of the voice coil support part 6 opposite to the side of the vibration direction converter part is formed in a concave shape in the side of the voice coil 60. The voice coil support part 6 vibrates in response to vibration of the voice coil 60 and is formed in a planar shape so that contact with the attachment unit 81 is prevented. Specifically, a comparatively large interval is formed between the connecting part 87a of the attachment unit 81 and another side edge part 6d of the voice coil support part 6, and the voice coil support part 6 is formed in a planar shape projecting toward the second holding part 88B as gradually approaching to the side of flat parts 88e at both left and right end parts of the second holding part 88B. Further, since the second holding part 88B is formed with a continuous member, the central part is formed also in a continuous shape. However, the second holding part 88B may be formed with a plurality of members, and the configuration of the second holding part 88B is not restricted. Although a part of the second holding part 88B is arranged projecting outside the static part 100, the second holding part 88B is not restricted to this configuration, and may be modified so as to be housed inside the static part 100. The flat parts 88e at both left and right end parts of the second holding part 88B include hole parts in which connecting parts 6e at both left and right end parts of another side edge part 6d of the voice coil support part 6 are inserted.

FIG. 26 is an enlarged perspective view of essential parts in a state where the first component member 110 is vertically placed upside down, and FIG. 26(a) specifically shows the terminal connecting face (second face) 88b of the first holding part 88A connected to a terminal part member 91. FIG. 26(b) specifically shows a connecting face (third face) 88d of the first holding part 88A connected to terminal parts 60P1, 60Q1 of lead wires 60P, 60Q from the end parts of the voice coil 60. The terminal connecting face 88b in the one end side of the first holding part 88A is connected to the terminal part member 91 and the connecting face 88d in the another end side is connected to lead wires 60P, 60Q of the voice coil 60 via the terminal parts 60P1, 60Q1. The terminal part member 91 electrically connects one end part of a pair of the first holding part 88A to a wire 92 (outside), and an audio signal inputted from the wire 92 is supplied to the lead wires 60P, 60Q of the voice coil 60 via the terminal part member 91 and the first holding part 88A. The terminal part member 91 is a rod shaped conductive member having a positioning hole 91A. With a positioning projection 111 provided at the static part 100 inserted into this positioning hole 91A, the terminal part member 91 is positioned to a specific location of the static part 100. A part of the terminal part member 91 is electrically insulated, and the surface of the conductive member is exposed in area of the conductive member connected to the terminal connecting face 88b of the first holding part 88A and can be electrically connected with the first holding part 88A. With the terminal part member 91 formed with a member having insulating property (insulating member) such as a resin member, etc., a conductive member may be provided on the insulating member to electrically connect to the terminal connecting face 88b of the first holding part 88A.

The vibration direction converter part 7 is connected to the connection unit 82 attached to one side edge part 6c of the voice coil support part 6. The integral component shown in FIG. 13 is adopted as the vibration direction converter part 7, and the joining part 200 formed at the end part of the vibration direction converter part is attached to a connecting step part 82A formed at the side face of the connection unit 82, such that the connection unit 82 is detachably connected to the vibration direction converter part 7. Further, as necessary, the connection unit 82 includes a through hole 82B passing through in the vibration direction of the voice coil 60. The through hole 82B is a vent hole to reduce air resistance exerted on the connection unit 82 in response to vibration of the voice coil support part 6. The connection unit 82 connects a first connecting part 53A of the vibration direction converter part 7 with an end part of the voice coil support part 6 at an interval, and thus the height of the magnetic circuit 40 is less than the height of the vibration direction converter part 7.

Further, the vibration direction converter part 7 is connected to an attaching counterpart 300 including the diaphragm 2 or the voice coil 60, or other member except the diaphragm 2 and the voice coil 60, for example, with a connecting member such as adhesive or a double-face adhesive tape as a joining member, or a screw, etc. as a fastening member, and a joint part 270B is arranged in the proximity of the attaching counterpart 300. In the face side of the attaching counterpart 300 in the proximity of the joint part 270A, 270B or 274B, etc. of the vibration direction converter part 7, a contact avoiding part 310 preventing the attaching counterpart 300 from contacting the joint part 270A, 270B and 274B, etc. is provided. The contact avoiding part 310 functions as a joining member restraining part restraining a joining member connecting the attaching counterpart 300 with the vibration direction converter part 7. For example, the contact avoiding part 310 is a concave part, a notch part, a groove part, etc. formed in a concave shape along the joint parts 270A, 270B, 274B, etc., providing a predetermined space between the joint part 270A, 270B, 274B, etc. and the surface of the attaching counterpart 300 arranged in the proximity of the joint part 270A, 270B, 274B, etc., thereby preventing the adhesive member arranged between the vibration direction converter part 7 and from affecting the joint parts 270A, 270B,274B, etc. In the example shown in FIG. 20, a concave part is formed as the contact avoiding part 310 at the joining part 200 of the vibration direction converter part 7 in the proximity of the joint part 270A, the joining part 200 being the attaching counterpart 300. A concave part is formed as the contact avoiding part 310 at the diaphragm 2 in the proximity of the joint part 270B. A concave part is formed as the contact avoiding part 310 at the fourth link part 273 in the proximity of the joint part 274B. Therefore, when a part of the vibration direction converter part 7 or the vibration direction converter part 7 and the end face of the diaphragm 2 are joined by a joining member such as adhesive or a double-face tape, the adhesive or the end part of the double-face tape protruding toward the joint parts 270A, 270B enters into the concave part of the contact avoiding part 310, thereby preventing the joining member from contacting with and adhering to the joint parts 270A, 270B, 274B, etc.

A pair of common terminal members 91, 91 with respect to a plurality of the voice coils 60, 60, extending from one voice coil 60 to another voice coil 60 among a plurality of voice coils, is provided at the static part 100 in order to input an audio signal to the voice coils 60, 60 corresponding to a plurality of the driving parts 14. Further, the terminal members 91, 91 are arranged in an opening (not shown) formed between the first component member 110 and the second component member 120, which configure the frame 12 as the static part 100. As such, space may be saved in arrangement of the terminal part compared to the case in which an individual terminal part is arranged at both end portions of each voice coil 60, and thus a speaker device may be made small or thin. Further, the terminal members 91, 91 may be stably fixed to the static part 100, and thereby a bad connection to the voice coils 60, 60 may be avoided. Further, the terminal members 91, 91 are formed to have a long axis extending from one voice coil 60 to another voice coil 60 and a short axis crossing the long axis. With the long and thin shape as above, efficiency of the installation space may be improved.

The terminal members 91, 91 include connecting parts 91a connected to wires 92, 92 (second wire), which are electrically connected to outside and the terminal members 91, 91 are electrically connected at the connecting part 81a. The wires 92 are fixed to the side face of the static part 100 and connected to the terminal members 91, 91. The outer peripheral frame part 101 of the static part 100 includes a side face to which a wire 92 is attached, and guiding parts 106, 106 guiding the wire 92 are formed at the side face of the static part 100.

Further, a conducting layer 32, connected to the lead wire 31 extending from the end portion of the voice coil 60, is formed on the voice coil support part 40 (base) supporting the voice coil 60. The conducting layer 32 is pattern-formed on the voice coil support part 6 (base) surrounding the conducting member of the voice coil 60, and this conducting layer 32 electrically connects the conducting member of the voice coil 60 and the holding part 15.

A wire, electrically connecting the voice coil 60 and the terminal members 81, is formed at the holding part 15 and the end portions of the terminal members 91, 91 and the wire are electrically connected. The wire of the holding part 15 and the voice coil lead wire are connected, and the terminal members 91, 91 and the wire 92 are connected, and thereby an external audio signal is inputted to the voice coil 60.

A connecting part F1, connected to the terminal members 91, 91, is formed at the holding part 15. This connecting part F1 extends in the direction crossing the vibration direction of the diaphragm 2 (X-axis direction), and is formed in a tabular shape so as to contact with the terminal members 91, 91. Also, a connecting part F2, connected to the conducting layer 32, is formed at the holding part 15. The connecting part F2 extends in the direction crossing the vibration direction (Z-axis direction) of the diaphragm 2 and is formed in a tabular shape so as to contact with the end portion of the conducting layer 32.

FIG. 27 is a view illustrating an assembly process of a whole speaker device. A convex part 100m projecting toward the attachment unit 81 is formed in one member of the first component member 110 and the second component member 120, and a concave part 100n in which the convex part 100m is inserted is formed in another member of the first component member 110 and the second component member 120, and the attachment unit 81 has hole parts 89 formed at the four corners, which the convex parts 100m pass through. In the example shown in the drawing, a plurality of the convex parts 100m are provided at the inner side of the first component member 110 and the hole parts 89 are provided by opening at a flange parts 84a of the arm parts 84 opposing to the convex parts 100m, and the concave parts 100n are provided in the inner side of the second component member 120. A through hole may be provided in place of the concave part 100n.

When assembling the speaker device 1W, the joining parts 200 of the vibration direction converter part 7 are inserted into the connection units 82 respectively, thereby the vibration direction converter part 7, the already unitized attachment unit 81, the voice coil support part 6, the holding part 8 (first holding part 88A, second holding part 88B) are unified. With the hole part 89 of the attachment unit 81 fitted to the convex part 100m of the first component member 110 or the second component member 120, a pair of magnetic pole members (yoke part 41, magnet 42) of the magnetic circuits 40 are positioned with respect to the static part 100 respectively sandwiching the voice coils 60, and thus the first component member 110 and the second component member 120 sandwich the voice coils 60. With this configuration, a static sixth link part 275 of the vibration direction converter part 7 is fitted into a supporting base 120B formed at a bottom part 120A of the second component member 120 and is fixedly supported, and other components such as the attachment unit 81, etc. are also arranged at a predetermined position with respect to the first component member 110 and the second component member 120. Also, the convex parts 100m provided at the first component member 110 of the static part 100 are inserted into the connection hole parts 89 provided at the four corners of the attachment units 81, and the static part 100 is fixed at a prescribed position.

In the example shown in the drawing, one of the magnetic pole members (yoke part 41, magnet 42) of the magnetic circuit 40 is incorporated, then the attachment unit 81, the vibration direction converter part 7, etc. are sequentially incorporated and positioned respectively in the inner face of the first component member 110, and then the second component member 120 is overlaped and sandwiches each components, and incorporates another magnetic pole member (yoke part 41, magnet 42) of the magnetic circuit 40. Accordingly, with the convex part 100m formed at the first component member 110 inserted into the hole part 89 of the attachment unit 81 and the concave part 100n of the second component member 120, the attachment unit 81, the voice coil support part 6 and the holding part 8 (first holding part 88A, second holding part 88B) are fixed between the first component member 110 and the second component member 120. Finally, a fourth link part 273 of the vibration direction converter part 7 and the diaphragm 2 are connected with adhesive as a joining member, and the outer periphery part of the diaphragm 2 is attached to the rim part of the central opening part of the first component member 110 via the edge 5.

Also, the following assembly process may be adopted. First, the wire 92 is connected with terminal members 91, 91 (connecting process between a connecting terminal part and a wire). Next, the magnet 42 is connected to the yoke part 41 (assembly process of the magnetic circuit). Next, terminal members 91, 91 connected with the wire 92 are attached to the outer peripheral frame part 101A of the first component member 110 (attachment process of the static part and the connecting terminal part). Next, a pair of attachment unit 81 to which the above-mentioned voice coil 60 is attached are attached to the first component member 110 (attachment process between the static part and the attachment unit). Concurrently, the terminal members 91, 91 and a holding part 15A attached to the attachment unit 81 are electrically connected by soldering, etc. (connecting process between the connecting terminal part and the holding part). Next, a connecting part 104 is attached to the voice coil 60 (attachment process between the voice coil and the connecting part). Next, the vibration direction converter part 7 is attached to the connecting part 104 (connecting process between the vibration direction converter part and the connecting part). Next, the static sixth link part 275 of the vibration direction converter part 7 is attached to the supporting base 120B formed at the bottom part 120A of the second component member 120 (attachment process between the vibration direction converter part and the second component member). Next, the second component member 120 is arranged on the first component member 110 (assembly process of the static part). After that, the magnetic pole member (yoke part) 41 connected to the magnet 42 is attached to the outer peripheral frame part 101A of the second component member 120 (attachment process between the static part and the magnetic circuit). Next, the diaphragm 2 and the edge 5 (vibrating body) are attached to a second peripheral frame part 101B of the first component member 110 (attachment process between the static part and the vibrating body). Next, the vibrating body and the vibration direction converter part are connected (attachment process between the vibrating body and the vibration direction converter part). Next, the magnetic pole member (yoke part) 41 joined to the magnet 42 is attached to a first outer peripheral frame part 101A of the first component member 110 (attachment process between the static part and the magnetic circuit). Finally, the wire 92 is attached to a guiding part 106 provided at the first outer peripheral frame part 101A of the first component member 110 (attachment process between the static part and the wire). The order of the processes described above may be altered as necessary.

As described above, the frame 3 as the static part 100 includes a first frame 110 as the first component member, and a second frame 120 as the second component member, and the first frame 110 is provided at the sound emission side of the speaker device 1W, and the second frame 120 is provided at the opposite (back) side of the sound emission side. The driving part 14 of the speaker device 1 is supported by being sandwiched between the first frame 110 and the second frame 120.

The annular peripheral frame part 101 of the first frame 110 supports one side (41B) of the magnetic pole member (yoke part) 41 of the magnetic circuit 40. Meanwhile, the second frame 120 includes the outer peripheral frame part 101 and the bridge part 102, and supports one side (41A) of the magnetic pole member (yoke part) 41 of the magnetic circuit 40.

The first frame 110 and the second frame 120 includes a concave receiving part 105 receiving part of the yoke part 41. A projection part 41p of the yoke part 41 is fitted into the receiving part 105, thereby the yoke part 41 is positioned to form a proper magnetic gap. Further, an opening part 101S is formed between the outer peripheral frame part 101 and the bridge part 102 in the second frame 120. A fourth projection part (not shown) is formed at the outer peripheral frame part 101 along the outer periphery edge part of the opening part 101S. The fourth projection part increases torsional rigidity of the peripheral frame part 101.

Further, the first frame 110 includes an excessive-vibration restraining part 108 (see FIG. 26) restraining excessive-vibration of the voice coil 60. The excessive-vibration restraining part 108 protrudes in a moving area of the voice coil 30, particularly in a notch part formed at end edge part in the vibration direction of the voice coil 30. The voice coil support part 6 contacts with the excessive-vibration restraining part 108, and thus excessive-vibration of the voice coil 60 is restrained.

The magnetic circuit 40 is attached to the first frame 110 and the second frame 120 with the magnetic pole member 22 being connected to the magnet. The magnetic pole member 22 includes a plurality of projection parts 41p, and the projection parts 41p are supported by the receiving part 105. The yoke part 41 being plate-shape magnetic body is reduced in the width from the vibration direction converter part 7 to the static part 100, and thus the holding part 15 is prevented from contacting with the yoke part 41.

In the magnetic circuit 40, the yoke parts 41A and 41B are attached to the first frame 110 and the second frame 120, and the first frame 110 and the second frame 120 are joined such that the interval as the magnetic gap 20G is provided between the yoke parts 41A and 41B or between the magnets 42.

With a plurality of the component members, accurate positioning for each of the component members is required when assembling the above-mentioned speaker device. In addition, when assembling a plurality of the component members, a process of assembling becomes complicated. However, in the speaker device 1W using the attachment unit 81, the holding part 8, the magnetic circuit 40 or the static part 100 can be accurately positioned with respect to the voice coil 60. Also, with the attachment unit 81, a plurality of the components are unitized, thereby increasing an efficiency in assembling while facilitating inspection in the process of manufacturing, and thereby reducing a defect rate. Also, even if a defect occurs in the voice coil 60 or the holding part 8, with the attachment unit 81, the voice coil 60 and the holding part 8 can be detached or replaced as a single set. Further, in an assembled state, an interval is formed between the first component member 110 and one magnetic pole member (yoke part 41) of the magnetic circuit 40 arranged in the proximity of the first component member 110, such that contact between the magnetic circuit 40 and the voice coil 60, caused by the vibration of the diaphragm 2 transmitted to the magnetic circuit 40 via one magnetic pole member (yoke part 41), can be prevented.

According to this Embodiment, the height of the magnetic circuit 40 is nearly equal to the total height of the whole device, and the voice coil support part 6 vibrates in the proximity of center of the magnetic circuit 40, and the end part of the voice coil support part 6 and the end part of the vibration direction converter part 7 are connected at different heights via the connection unit 82. As such, each link part of the vibration direction converter part 7 can obtain a sufficient length within a height of the device, and a part of the height of the magnetic circuit 40 can be included within the height of the vibration direction converter part 7.

Accordingly, the speaker device according to embodiments or examples of the present invention can be made thin and can make louder sound. Further, a thin speaker device capable of emitting louder reproduced sound with a comparatively simple structure can be realized by vibrating the diaphragm in a direction different from the vibration direction of the voice coil. When converting the vibration direction of the voice coil to a different direction by using a mechanical link body, durability of the hinge part of the link body that can tolerate the high-speed vibration specific to a speaker device and flexibility that can restrain generation of abnormal sound during high-speed vibration, may be required. According to the configuration of the speaker device described above, the hinge part of the link body can have the durability and flexibility.

Further, in order to direction convert the vibration of the voice coil and transmit the vibration of the voice coil to the diaphragm, it is necessary to efficiently and accurately reproduce the vibration of the voice coil, and thus it may be necessary to prevent the link body from being deformed and make the link body itself light. In addition, it may be necessary to easily incorporate the link body into the speaker device and easily manufacture the link body itself. According to the configuration of the speaker device described above, a speaker device, which is light weight and easy to manufacture, can be realized.

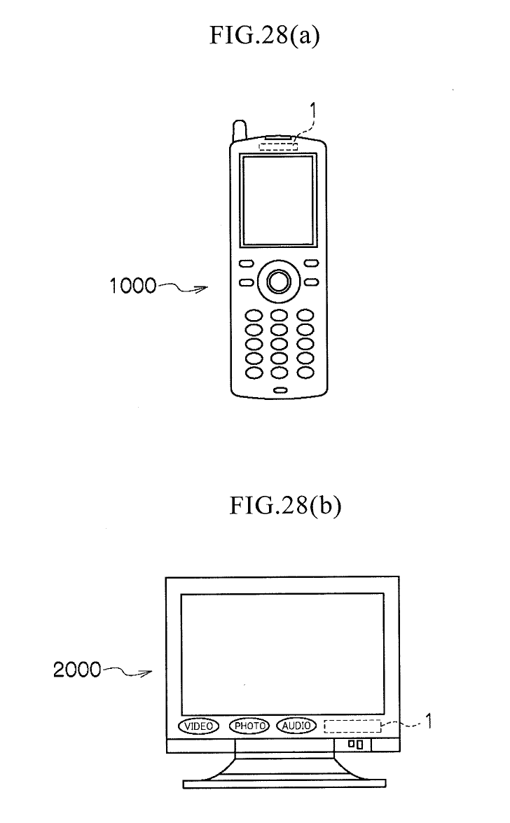

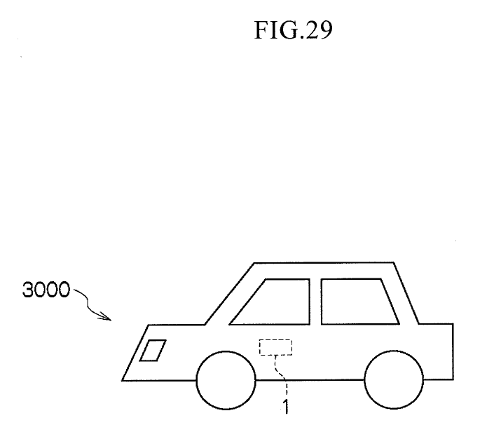

This speaker device can be efficiently used as various types of electronic devices or in-car devices. FIG. 28 is a view illustrating an electronic device including a speaker device according to an embodiment of the present invention. In an electronic device 1000 such as a mobile phone or a handheld terminal shown in FIG. 28(a) or an electronic device 2000 such as a flat panel display shown in FIG. 28(b), a speaker device is housed in the housing, which act as the attaching counterpart provided at the electronic device 2000. And the speaker device is attached to the side face of the housing as the attaching counterpart of the electronic device. Even if this case, since installation space in thickness direction required for installing the speaker device 1 may be decreased, the whole electronic device may be made thin. Further, a sufficient audio output may be produced even by the electronic device made thin. FIG. 29 is a view illustrating an automobile provided with a speaker according to an embodiment of the present invention. In an automobile 3000 shown in FIG. 29, in-car space may be widened with the speaker device 1 made thin. More particularly, the speaker device 1 according to the embodiment of the present invention, even if attached to a door panel, ceiling, rear tray or a dashboard as the attaching counterpart, may comparatively reduce a bulge projecting into a door panel, ceiling, and thus enabling to widen space for a driver to operate or space inside room. Further, with sufficiently produced audio output, it is possible to enjoy listening to music or radio broadcasting pleasantly in a car even when driving on a noisy highway.

Further in a resident building, a hotel, an inn or a training facility as a building including a speaker device, when the speaker device 1 is provided on a wall or ceiling as the attaching counterpart, installation space in thickness direction required for the speaker device 1 may be reduced and thus enabling to save space in a room and make effective use of space. The hotel is capable of holding an event and accommodating many guests for conference, meeting, lecture, party, etc. Further, providing a room equipped with audiovisual equipment can be seen in recent years along with prevalence of a projector or a big-screen TV. On the other hand, there is also seen a living room, etc. used as a theater room without room equipped with audiovisual equipment. Also in this case, the living room, etc. can be easily converted to a theater room with the speaker device 1 while making effective use of space in the living room. More particularly, the placement at which the speaker device 1 is arranged may be, for example, ceiling or wall, etc. (attaching counterpart).

Although the embodiments according to the present invention are described with reference to the drawings, specific configurations are not limited to these embodiments, and modifications not departing from the subject matter of the present invention are included in the scope of the present invention. Further, the technology of each embodiment described above can be used by each other, unless specific contradictions or problems are found in their objects, the configurations, etc. In addition, PCT/JP2008/051197 filed on Jan. 28, 2008, PCT/JP2008/068580 filed on Oct. 14, 2008, PCT/JP2008/069480 filed on Oct. 27, 2008, PCT/JP2009/053752 filed on Feb. 27, 2009, PCT/JP2009/053592 filed on Feb. 26, 2009, PCT/JP2009/050764 filed on Jan. 20, 2009, PCT/JP2009/055533 filed on Mar. 19, 2009, PCT/JP2009/055496 filed on Mar. 19, 2009, PCT/JP2009/055497 filed on Mar. 19, 2009, PCT/JP2009/055498 filed on Mar. 19, 2009, PCT/JP2009/055534 filed on Mar. 19, 2009, PCT/JP2009/055523 filed on Mar. 19, 2009, PCT/JP2009/055524 filed on Mar. 19, 2009, PCT/JP2009/055525 filed on Mar. 19, 2009, PCT/JP2009/055526 filed on Mar. 19, 2009, PCT/JP2009/055527 filed on Mar. 19, 2009, PCT/JP2009/055528 filed on Mar. 19, 2009 are incorporated by reference into the present application.

1. A speaker device comprising:
a diaphragm;
a static part vibratably supporting said diaphragm; and
a driving part provided at said static part, vibrating said diaphragm upon an audio signal, wherein
said driving part includes:
a tabular plate shape voice coil vibrating in a direction different from a direction in which said diaphragm vibrates in response to an audio signal inputted,
a magnetic circuit having a magnetic gap in which said voice coil is arranged,
a rigid vibration direction converter part transmitting said vibration of said voice coil to said diaphragm, and
a holding part holding said voice coil at said static part such that said voice coil vibrates linearly, and
said vibration direction converter part is connected with said voice coil and said diaphragm, and
said audio signal inputted to an audio signal input terminal provided at said static part is inputted to said voice coil via said holding part.

2. The speaker device according to claim 1, wherein
said holding part, which is formed with a conductive metal, is electrically connected with an end part of said voice coil or a lead wire from said end part of voice coil,
said audio signal input terminal is electrically connected with an end part of said holding part in the side of said static part.

3. The speaker device according to claim 2, wherein said holding part restricts said vibration of voice coil in one axis direction.

4-6. (canceled)

7. The speaker device according to claim 3, comprising a voice coil support part supporting said voice coil, wherein
a connection unit connecting said voice coil support part to said vibration direction converter part is provided,
said holding part holds said voice coil via said connection unit,
said connection unit is provided between a pair of said holding parts, and
an end edge part in the vibration direction of said voice coil support part is attached to said connection unit.

8. The speaker device according to claim 3, comprising a voice coil support part supporting said voice coil, wherein
an attachment unit which is arranged so as to surround both side edge parts in the vibration direction of said voice coil and another end edge part in the vibration direction of said voice coil is provided,
an end part of said holding part is attached to a connecting part of said attachment unit, said connecting part being located outside both side edge parts in the vibration direction of said voice coil,
a central part of an integral holding part integrating said right and left holding parts is supported by an attachment end part located outside another end edge part in the vibration direction of said voice coil, and
a voice coil support part is attached to said a frame as said static part via said attachment unit.

9-10. (canceled)

11. The speaker device according to claim 1, wherein
a frame is provided as said static part, and
said vibration direction converter part includes a link body that angle converts a link part formed between said voice coil and said diaphragm.

12. The speaker device according to claim 1, wherein
a frame is provided as said static part and said frame includes a planar bottom face,
said diaphragm is planarly supported along the bottom face of said frame, and
said magnetic gap is formed along said bottom face of said frame, and
said link body angle converts said link part upon receiving with a reaction force applied to said link part from said bottom face of said frame.

13-18. (canceled)

19. The speaker device according to claim 1 comprising,
an attachment unit holding said voice coil with respect to said static part via said holding part, wherein
said attachment unit arranges said voice coil at a prescribed position with respect to said static part.

20. The speaker device according to claim 19, wherein
said attachment unit includes a plurality of arm parts arranged along both side edge parts of said voice coil, the arm parts extending in the vibration direction of said voice coil, and a bridge part connecting said arm parts, and
said arm part supports said holding part connected with said voice coil.

21-27. (canceled)

28. The speaker device according to claim 20, wherein
said static part includes a first component member arranged in the side of said diaphragm and a second component member opposing the first component member, and
said attachment unit is attached to said first component member or said second component member.

29-32. (canceled)

33. The speaker device according to claim 28, wherein
said attachment unit is positioned with respect to said static part, by fitting into said first component member or said second component member.

34. The speaker device according to claim 33, wherein
one of said first component member and said second component member includes a convex part projecting toward said attachment unit, and
another of said first component member and said second component member includes a concave part in which said convex part is inserted, and
said attachment unit includes a hole part said convex part passes through.

35. (canceled)

36. The speaker device according to claim 1, wherein
a part of wire for inputting an audio signal inputted from outside to said voice coil is formed at said one holding part,
said one holding part includes a curved part having a curved planar shape, and
a tabular portion continuously formed from said curved part, having a linear cross-sectional shape,
said one holding part includes a third face protruding from said tabular portion as a first face and extending in the direction intersecting said first face, and
said third face is formed near the end part in the side of said voice coil and electrically connected with said voice coil.

37. The speaker device according to claim 1, wherein
said vibration direction converter part includes one end part angle-variably connected with said voice coil directly or indirectly via other member, and
another end part angle-variably connected to said diaphragm directly or indirectly via other member, and
a rigid link part disposed slantwise with respect to the vibration direction of said diaphragm and the vibration direction of said voice coil, respectively.

38. The speaker device according to claim 1 comprising a connecting part between said end part in the side of said voice coil of said vibration direction converter part and said end part in the side of said vibration direction converter part of said voice coil, wherein said connecting part connects both of said end parts arranged in different positions from each other in said vibration direction of said diaphragm.

39. The speaker device according to claim 1, wherein
said vibration direction converter part is connected to an attaching counterpart including said diaphragm and said voice coil, and
said vibration direction converter part includes a joint part in proximity of said attaching counterpart, and
a contact avoiding part preventing said attaching counterpart from contacting with said joint part are formed in the face side of said attaching counterpart in proximity of said joint part.

40. The speaker device according to claim 1, wherein
said vibration direction converter part is connected to an attaching counterpart including said diaphragm and said voice coil, and
said vibration direction converter part includes a joint part in proximity of said attaching counterpart, and
a housing part of adhesive member connecting said vibration direction converter part with said attaching counterpart is formed in the face side of said attaching counterpart opposing said joint part.

41. The speaker device according to claim 1, wherein
said vibration direction converter part includes a rigid link part disposed slantwise angle-variably between said voice coil and said diaphragm, and joint parts formed at both end parts of said link part, and
said joint parts are formed with a bendable continuing member continuing between parts of said joint part in both sides across said joint part.

42. The speaker device according to claim 1, wherein
said voice coil includes a planarly and annularly wound conducting member,
said voice coil support part includes a rigid base supporting said conducting member, and
a conducting layer is pattern formed at a surface in the outer side of said conducting member in said base.

43. The speaker device according to claim 42, wherein
a pair of said conducting layers is arranged so as to surround said conducting member and functions as a junction wire inputting said audio signal to said conducting member.

44-48. (canceled)

49. An electronic device comprising the speaker device according to claim 1.

50. A vehicle comprising the speaker device according to claim 1.

51. A building comprising the speaker device according to claim 1.
